(19) United States
(12) Patent Application Publication
(10) Pub. No.: US 2026/0181713 A1
(43) Pub. Date: Jun. 25, 2026

(54) DATA OBTAINING METHOD AND APPARATUS, DEVICE, AND READABLE STORAGE MEDIUM

(71) Applicant: VIVO MOBILE COMMUNICATION CO., LTD., Guangdong (CN)

(72) Inventor: Weiwei CHONG, Guangdong (CN)

(73) Assignee: VIVO MOBILE COMMUNICATION CO., LTD., Guangdong (CN)

(21) Appl. No.: 19/541,211

(22) Filed: Feb. 16, 2026

Related U.S. Application Data
(63) Continuation of application No. PCT/CN2024/111909, filed on Aug. 14, 2024.

(30) Foreign Application Priority Data
Aug. 21, 2023 (CN) 202311056764.8

(51) Int. Cl. H04W 76/11; H04W 76/30

(52) U.S. Cl. CPC H04W 76/11; H04W 76/30

(57) ABSTRACT

This application provides a data obtaining method and apparatus, a device, and a storage medium, which can enable a first communication device to obtain data corresponding to address information of a session of a terminal device at a historical time. The data obtaining method includes: obtaining, by the first communication device, first information of a terminal device, where the first information is used for indicating the address information of the session of the terminal device at the historical time, and the session includes a session in which the terminal device reports data to the first communication device; and obtaining, by the first communication device based on the first information, data of the terminal device at a first time, where the first time overlaps with the historical time.

### CROSS-REFERENCE TO RELATED APPLICATIONS

This application is a U.S. national phase application of a PCT Application No. PCT/CN2024/111909 filed on Aug. 14, 2024, which claims priority to Chinese Patent Application No. 202311056764.8 filed in China on Aug. 21, 2023, which is incorporated herein by reference in its entirety.

### TECHNICAL FIELD

This application relates to the communication field, and more specifically, to a data obtaining method and apparatus, a device, and a readable storage medium.

### BACKGROUND

In some communication mechanisms, due to a requirement, such as a data analytics requirement, a data consumer, such as a network data analytics function (NWDAF) in a network, needs to request terminal device-related data by using a data proxy, such as a data collection application function (DCAF). For example, the NWDAF obtains the terminal device-related data from the DCAF based on an identifier of the terminal device. The DCAF requests and obtains data from the corresponding terminal device. The data is uploaded to the DCAF through a user plane session, and the data is indexed by an address of the terminal device, such as an Internet Protocol (IP) address. Therefore, there is a requirement that the DCAF needs to map the identifier of the terminal device to address information of the terminal device.

In the related art, before the DCAF obtains data from the terminal device, it is assumed that the user plane session of the terminal device has existed and has not been released, that is, the IP address corresponding to the user plane session of the terminal device has always existed and has not changed. When the DCAF has a data obtaining requirement, the session and the IP address may be used to obtain data from the corresponding terminal device immediately. However, there are some scenarios in which when the session of the terminal device is released or changes, and the IP address assigned to the terminal device is deleted or changed, or even assigned to other terminal devices for use, the DCAF cannot correctly obtain historical data of the corresponding terminal device based on the original IP address.

### SUMMARY

This application provides a data obtaining method and apparatus, a device, and a storage medium.

According to a first aspect, a data obtaining method is provided, including:
obtaining, by a first communication device, first information of a terminal device, where the first information is used for indicating address information of a session of the terminal device at a historical time, and the session includes a session in which the terminal device reports data to the first communication device; and
obtaining, by the first communication device based on the first information, data of the terminal device at a first time, where the first time overlaps with the historical time.

According to a second aspect, a data obtaining method is provided, including:
obtaining, by a second communication device, first information of a terminal device, where the first information is used for indicating address information of a session of the terminal device at a historical time, and the session includes a session in which the terminal device reports data to a first communication device; and
sending, by the second communication device, the first information to the first communication device.

According to a third aspect, a data obtaining method is provided, including:
sending, by a consumer device, a second request message to a first communication device, where the second request message includes first time information, and the second request message is used for obtaining data of a terminal device at a first time; and
receiving, by the consumer device, a response message from the first communication device, where the response message includes the data of the terminal device at the first time, the data of the terminal device at the first time is obtained based on first information of the terminal device, and the first information is used for indicating address information of a session of the terminal device at a historical time.

According to a fourth aspect, a data obtaining apparatus is provided, including:
a first obtaining unit, configured to obtain first information of a terminal device, where the first information is used for indicating address information of a session of the terminal device at a historical time, and the session includes a session in which the terminal device reports data to a first communication device; and
a second obtaining unit, configured to obtain, based on the first information, data of the terminal device at a first time, where the first time overlaps with the historical time.

According to a fifth aspect, a data obtaining apparatus is provided, including:
an obtaining unit, configured to obtain first information of a terminal device, where the first information is used for indicating address information of a session of the terminal device at a historical time, and the session includes a session in which the terminal device reports data to a first communication device; and
a sending module, configured to send the first information to the first communication device.

According to a sixth aspect, a data obtaining apparatus is provided, including:
a sending unit, configured to send a second request message to a first communication device, where the second request message includes first time information, and the second request message is used for obtaining data of a terminal device at a first time; and
a receiving unit, configured to receive a response message from the first communication device, where the response message includes the data of the terminal device at the first time, the data of the terminal device at the first time is obtained based on first information of the terminal device, and the first information is used for indicating address information of a session of the terminal device at a historical time.

According to a seventh aspect, a communication device is provided, including a processor and a memory, where the memory is configured to store a computer program, and the processor is configured to invoke and run the computer program stored in the memory, to perform the method provided in any one of the first aspect to the third aspect.

According to an eighth aspect, a computer-readable storage medium is provided to store a computer program, where the computer program enables a computer to perform the method provided in any one of the first aspect to the third aspect.

According to a ninth aspect, a chip is provided, including a processor, where the processor is configured to invoke, from a memory, and run a computer program, to enable the chip to perform the method provided in any one of the first aspect to the third aspect.

According to a tenth aspect, a computer program product is provided, including a computer program/instruction, where when the computer program/instruction is executed by a processor, the steps of the method provided in any one of the first aspect to the third aspect are implemented.

### BRIEF DESCRIPTION OF DRAWINGS

FIG. 1 is a schematic diagram of a communication system to which an embodiment of this application is applicable;

FIG. 2 is a schematic diagram of a network architecture to which an embodiment of this application is applicable;

FIG. 3 is a schematic diagram of a process of providing terminal device-related data to an NWDAF;

FIG. 4 is a schematic diagram of a process of obtaining a UE IP address corresponding to a UE ID;

FIG. 5 is a schematic diagram of a process in which a UE IP address is released in a communication scenario;

FIG. 6 is a schematic flowchart of a data obtaining method according to an embodiment of this application;

FIG. 7 is a schematic flowchart of another data obtaining method according to an embodiment of this application;

FIG. 8 is a schematic flowchart of another data obtaining method according to an embodiment of this application;

FIG. 9 is a schematic flowchart of another data obtaining method according to an embodiment of this application;

FIG. 10 is a schematic flowchart of another data obtaining method according to an embodiment of this application;

FIG. 11 is a schematic flowchart of another data obtaining method according to an embodiment of this application;

FIG. 12 is a schematic diagram of a data obtaining apparatus according to an embodiment of this application;

FIG. 13 is a schematic diagram of another data obtaining apparatus according to an embodiment of this application;

FIG. 14 is a schematic diagram of another data obtaining apparatus according to an embodiment of this application; and

FIG. 15 is a schematic diagram of an electronic device according to an embodiment of this application.

### DESCRIPTION OF EMBODIMENTS

The following describes technical solutions of this application with reference to accompanying drawings.

The technical solutions of the embodiments of this application may be applied to various communication systems, such as a global system for mobile communications (GSM) system, a code division multiple access (CDMA) system, a wideband code division multiple access (WCDMA) system, a general packet radio service (GPRS) system, a long term evolution (LTE) system, a system architecture evolved (SAE) system, an LTE frequency division duplex (FDD) system, an LTE time division duplex (TDD) system, a universal mobile telecommunication system (UMTS), a worldwide interoperability for microwave access (WiMAX) communication system, a 5th generation (5G) system or a new radio (NR) system, and a subsequently evolved communication system.

FIG. 1 is a schematic diagram of a communication system according to an embodiment of this application. A terminal device 110, an access network device 120, and a core network device 130 are included in FIG. 1. The terminal device 110 is connected to the access network device 120, and the access network device 120 is connected to the core network device 130, so that the terminal device 110 can communicate to the core network device 130 through the access network device 120.

The terminal device 110 in the embodiments of this application may also be referred to as: user equipment (UE), a mobile station (MS), a mobile terminal (MT), an access terminal, a user unit, a user station, a mobile console, a remote station, a remote terminal, a mobile device, a user terminal, a terminal, a wireless communication device, a user proxy, a user apparatus, or the like.

The terminal device 110 may be a device providing voice/data connectivity to a user, for example, a handheld device with a wireless connection function or a vehicle-mounted device. At present, some examples of the terminal are: a mobile phone, a tablet computer, a notebook computer, a palmtop, a mobile Internet device (MID), a wearable device, a virtual reality (VR) device, an augmented reality (AR) device, a wireless terminal in industrial control, a wireless terminal in autonomous driving, a wireless terminal in a remote medical surgery, a wireless terminal in smart grid, a wireless terminal in transportation safety, a wireless terminal in smart city, a wireless terminal in smart home, a cellular phone, a cordless phone, a session initiation protocol (SIP) phone, a wireless local loop (WLL) station, a personal digital assistant (PDA), a hand-held device with a wireless communication function, a computing device or another processing device connected to a wireless modem, a vehicle-mounted device, a terminal device in a 5G network or a terminal device in a public land mobile network (PLMN) of evolution, and the like, which are not limited in the embodiments of this application. For example, the terminal device 110 is used for receiving a paging message from the access network device 120.

As an example instead of a limitation, in the embodiments of this application, the wearable device may also be referred to as a wearable smart device, and is a general term of wearable devices that are intelligently designed and developed for daily wear by using a wearable technology, for example, glasses, gloves, watches, clothes, and shoes. The wearable device is a portable device that is worn directly on the body or integrated into clothes or accessories of the user. The wearable device is not only a hardware device, but also realizes powerful functions through software support, data interaction, and cloud interaction. Generally speaking, the wearable smart device includes a device that is fully-functional and large in size, and can realize complete or partial functions without relying on a smart phone, such as smart watches or smart glasses, and a device that focuses on only application functions, and needs to be used in cooperation with another device such as a smart phone, for example, various smart bracelets and smart jewelry for vital sign monitoring.

In addition, in the embodiments of this application, the terminal device 110 may also be a terminal device in an Internet of things (IoT) system. The IoT is an important part of future development of information technology, and its main technical feature is to connect articles with the network through communication technology, to realize an intelligent network featuring human-machine interconnection and object-to-object interconnection.

If various terminal devices 110 described above are located in a vehicle (for example, placed in the vehicle or installed in the vehicle), the terminal devices may be all considered as vehicle-mounted terminal devices. The vehicle-mounted terminal device is also referred to as, for example, an on-board unit (OBU).

In the embodiments of this application, the access network device 120 is a device in a radio access network ((radio) access network, (R)AN), a RAN node that connects the terminal device to a wireless network, or a device in a next generation radio access network (NG-RAN). For example, as an example rather than a limitation, as the access network device 120, the following may be listed: the next generation NodeB (gNB), a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB (HNB)), a base band unit (BBU), a wireless fidelity (Wi-Fi) access point (AP), or the like.

In a network structure, the access network device 120 may include a centralized unit (CU) node or a distributed unit (DU) node, or include a radio access network (RAN) device of the CU node and the DU node, or a RAN device of a control plane CU node (CU-CP node), a user plane CU node (CU-UP node), and the DU node.

The access network device 120 provides a service for a cell. The terminal device 110 communicates with the access network device 120 through a transmission resource used by the cell (for example, a frequency domain resource or a spectrum resource). The cell may be a cell corresponding to the access network device 120 (for example, a base station), and the cell may belong to a macro base station or belong to a base station corresponding to a small cell. Herein, the small cell may include: a metro cell, a micro cell, a pico cell, a femto cell, and the like. These small cells have the characteristics of small coverage and low transmission power, and are suitable for providing high-speed data transmission services.

The core network device 130 is used for managing one or more access network devices 120. For example, the core network device 130 is used for sending information to the access network device 120, which is used for the access network device to send a paging message. For example, the core network device 130 may include at least one of the following: a core access and mobility management function (AMF), a user plane function (UPF) network element, a session management function (SMF) network element, a data network (DN), unified data repository (UDR), or unified data management (UDM).

It should be understood that, for example, FIG. 1 shows a core network device 130, an access network device 120, and a terminal device 110. In some embodiments, the communication system may include other numbers of core network devices, access network devices, or terminal devices, and this is not limited in the embodiments of this application.

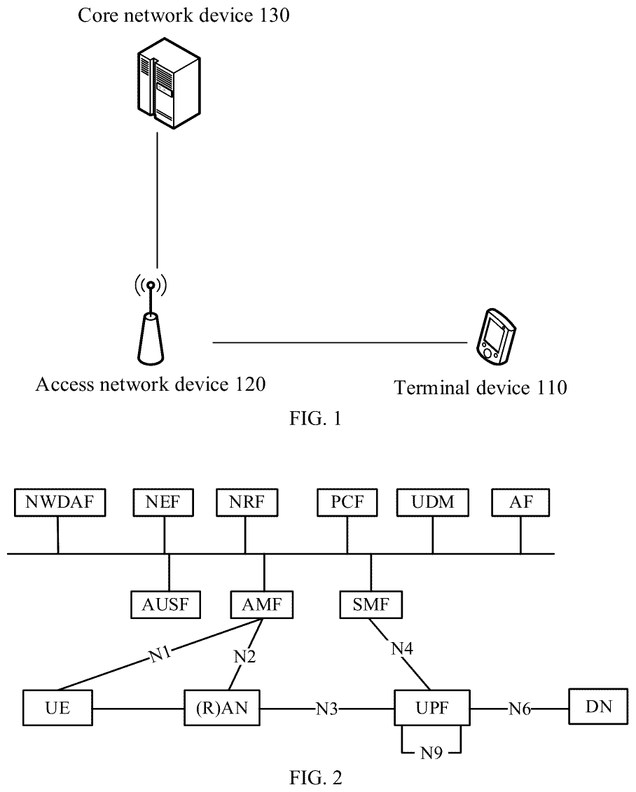

FIG. 2 is a schematic diagram of a network architecture to which an embodiment of this application is applicable. The network architecture is a 5G network architecture diagram defined by the 3rd generation partnership project (3GPP). It should be understood that the network architecture may further include more, fewer, or different functional components, which is not limited.

The access and mobility management function (AMF) is responsible for an access and mobility management function. Its main functions include managing user registration, reachability detection, selection of an SMF node, mobile state transition management, and the like. The AMF may communicate with the UE through an N1 interface and communicate with the (R)AN through an N2 interface.

The session management function (SMF) is responsible for a session management function. Its main functions are controlling establishment, modification, and deletion of a session, selection of a user plane node, and the like. The SMF may communicate with a user plane function (UPF) through an N4 interface.

The user plane function (UPF) mainly provides user plane support. Its main functions are data packet routing and forwarding, serving as a session anchor point, serving as an uplink classifier to route a traffic flow to a local data network, serving as a branch point to support a multi-homed PDU session, and the like. The (R)AN may communicate with the UPF through an N3 interface, and UPFs may communicate with each other through an N9 interface.

A policy control function (PCF) is responsible for user policy management. Its main function is a policy decision point, providing rules such as detection based on a service data flow or an application, quality of service (QoS) control, and flow-based billing control, and providing policies to the AMF and the SMF, such as providing a slice selection policy to the AMF and providing a session management policy to the SMF.

A main function of unified data management (UDM) is to store user data, such as subscription information, authentication/authorization information, and the like.

An authentication server function (AUSF) is an authentication and authorization service module, and is responsible for authenticating and authorizing access of the UE.

A main function of an application function (AF) is to interact with the 3GPP core network to provide a service, thereby influencing traffic flow routing, policy control, and the like.

The AF may include a data collection application function (DCAF), to provide a service related to data (such as user data) collection. The DCAF may be a network element deployed by an operator or a network element deployed by a third party, which is not limited.

A network exposure function (NEF) securely exposes a service and a capability provided by the 3GPP network function, such as exposing a service and a capability to a third party, edge computing, an AF, and the like. It is also possible to convert internal and external information, such as converting information outside 3GPP into information within 3GPP.

A data network (DN) is, for example, an operator service, Internet access, or a third-party service. The DN may communicate with the UPF through an N6 interface.

A network data analytics function (NWDAF) provides a network data collection and analytics function based on technologies such as big data and artificial intelligence.

A network repository function (NRF) provides network element registration and discovery, to enable network functions (NF) to discover each other for communication.

It should be noted that the network architecture in FIG. 2 is merely an example of a 5G network architecture. With the development of technology, some modules or functions of the network architecture may be optimized. The embodiments of this application are not only applicable to the network architecture in FIG. 2, but also applicable to other network architectures with the same or similar functions as the network architecture.

It should be understood that a device with a communication function in the network/system of the embodiments of this application may be referred to as a communication device. The communication system shown in FIG. 1 is used as an example. The communication device may include a terminal device 110, an access network device 120, and a core network device 130 that are of communication functions, and the like. This is not limited in the embodiments of this application.

It should be understood that the terms “system” and “network” in this specification are usually used interchangeably herein.

In the embodiments of this application, “predefinition” may be implemented by prestoring corresponding code or a corresponding table in a device (for example, a terminal device and a network device), or may be implemented in another manner that may indicate related information. A specific implementation is not limited in this application. For example, the predefinition may be definition through a protocol.

The “protocol” in the embodiments of this application may be a standard protocol in the communication field, and may include, for example, an LTE protocol, an NR protocol, and a related protocol applied to a future communication system. This is not limited in this application.

In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

The terms used in the embodiments of this application are only used for explaining specific embodiments of this application, and are not intended to limit this application. In the specification, claims, and accompanying drawings of this application, the terms “first”, “second”, “third”, “fourth” and so on are intended to distinguish between different objects but do not indicate a particular order. In addition, the terms “including” and “having” and any other variants thereof are intended to cover a non-exclusive inclusion.

It should be understood that the “indication” mentioned in the embodiments of this application may be a direct indication, an indirect indication, or indicate an association relationship. For example, A indicates B, which may indicate that A directly indicates B, for example, B may be obtained through A; may indicate that A indirectly indicates B, for example, A indicates C, and B may be obtained through C; and may indicate that there is an association relationship between A and B.

In the description of the embodiments of this application, the term “correspond” may indicate that there is a direct or indirect correspondence between the two, there is an association relationship between the two, or there is a relationship such as indicating and being indicated, and configuring and being configured.

In some communication mechanisms, due to a requirement, such as a data analytics requirement, a data consumer, such as an NWDAF in a network, needs to request terminal device-related data by using a data proxy, such as a DCAF.

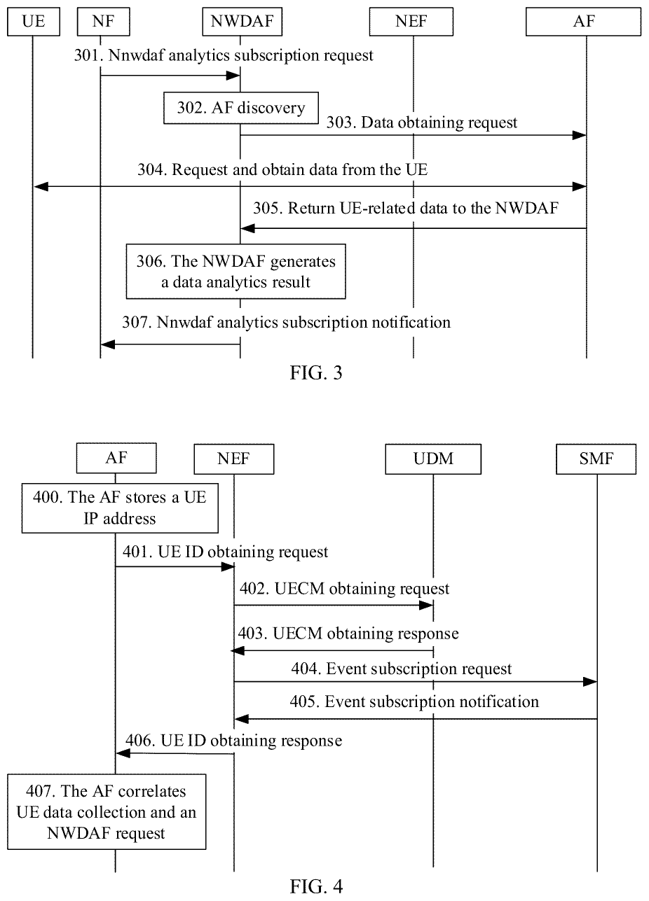

As a specific example, FIG. 3 is a schematic diagram of a process of providing terminal device-related data to an NWDAF. An example in which the terminal device is UE is used for description. As shown in FIG. 3, step 301 to step 307 are included.

301: The NF sends an Nnwdaf analytics subscription request to the NWDAF.

For example, the NF may send Nnwdaf_AnalyticsSubscription_Subscribe to the NWDAF, to provide a data analytics result from the NWDAF to the user NF, where the data analytics result needs to be generated by the NWDAF based on UE-related data.

302: The NWDAF performs AF discovery.

Specifically, as a data consumer, the NWDAF network element needs to request the UE-related data from the AF (specifically, a DCAF). For example, the NWDAF may query to obtain the corresponding DCAF.

303: The NWDAF sends a data obtaining request to the AF.

Specifically, the data obtaining request is used for requesting the UE-related data. As an example, the request may be Naf_Event_Exposure_Subsribe.

For example, a UE identifier (ID) may be carried in the data obtaining request, such as a subscription permanent identifier (SUPI) or a generic public subscription identifier (GPSI), which is not limited.

Optionally, when the DCAF is a third-party untrusted AF, the request message is first sent to the NEF, and then is forwarded by the NEF to the DCAF.

304: The AF requests and obtains data from the UE.

Specifically, the DCAF requests and obtains data from the corresponding UE, for example, data in a UE application or baseband may be collected to the AF (Data collection from UE application to AF). The data is uploaded to the DCAF through a user plane session, such as a PDU session.

305: The AF returns the UE-related data to the NWDAF.

For example, the AF may return the UE-related data by using Naf_Event_Exposure_Notify as a response of Naf_Event_Exposure_Subsribe.

306: The NWDAF generates the data analytics result.

Specifically, the NWDAF may use the UE-related data to fulfill its own data analytics task requirement.

307: The NWDAF sends an Nnwdaf analytics subscription notification to the NF.

For example, the NWDAF may send Nnwdaf_AnalyticsSubscription_Notify to the NF as a response of Nnwdaf_AnalyticsSubscription_Subscribe, to provide a data analytics result from the NWDAF to the user NF.

In FIG. 3, the UE-related data collected by the DCAF is indexed by using a UE IP address, that is, in step 304, the UE-related data is uploaded by using a user plane session corresponding to the UE IP address, such as a PDU session. However, when collecting data from the DCAF, the NWDAF uses a UE ID as an index, that is, the UE ID is carried in step 303. Therefore, in the foregoing process, there is a requirement for the DCAF to map the UE ID to the UE IP address.

As a specific example, FIG. 4 is a schematic diagram of a process of obtaining a UE IP address corresponding to a UE ID. As shown in FIG. 4, step 400 to step 407 are included.

400: The AF stores the UE IP address.

401: The AF sends a UE ID obtaining request to the NEF.

For example, the UE ID obtaining request may be: Nnef_UEid_Get_Request.

402: The NEF sends a UE context management (CM) obtaining request to the UDM.

For example, the UECM obtaining request may be: Nudm_UECM_Get_Request.

403: The UDM sends a UECM obtaining response to the NEF.

For example, the UECM obtaining response may be: Nudm_UECM_Get_Response.

404: The NEF sends an event subscription request to the SMF, to request the UE ID.

For example, the event subscription request may be: Nsmf_Event_Exposure_Subsribe.

405: The SMF sends an event subscription notification to the NEF, in which the UE ID is included.

For example, the event subscription notification may be: Nsmf_Event_Exposure_Notify.

406: The NEF sends a UE ID obtaining response to the AF.

For example, the UE ID obtaining response may be: Nnef_UEid_Get_Response.

407: The AF correlates UE data collection and an NWDAF request.

In step 401 to step 403, by using the NEF and the UDM, the DCAF obtains, through query, the SMF corresponding to the UE; and in step 404 to step 406, the DCAF requests and obtains the UE IP address corresponding to the UE ID from the SMF.

In the related art, before the DCAF obtains data from the terminal device, it is assumed that the user plane session of the terminal device has existed and has not been released, that is, the IP address corresponding to the user plane session of the terminal device has always existed and has not changed. When the DCAF has a data obtaining requirement, the session and the IP address may be used to obtain data from the corresponding terminal device immediately. However, there are some scenarios in which when the session of the terminal device is released or changes, and the IP address assigned to the terminal device is deleted or changed, or even assigned to other terminal devices for use, the DCAF cannot correctly obtain historical data of the corresponding terminal device based on the original IP address.

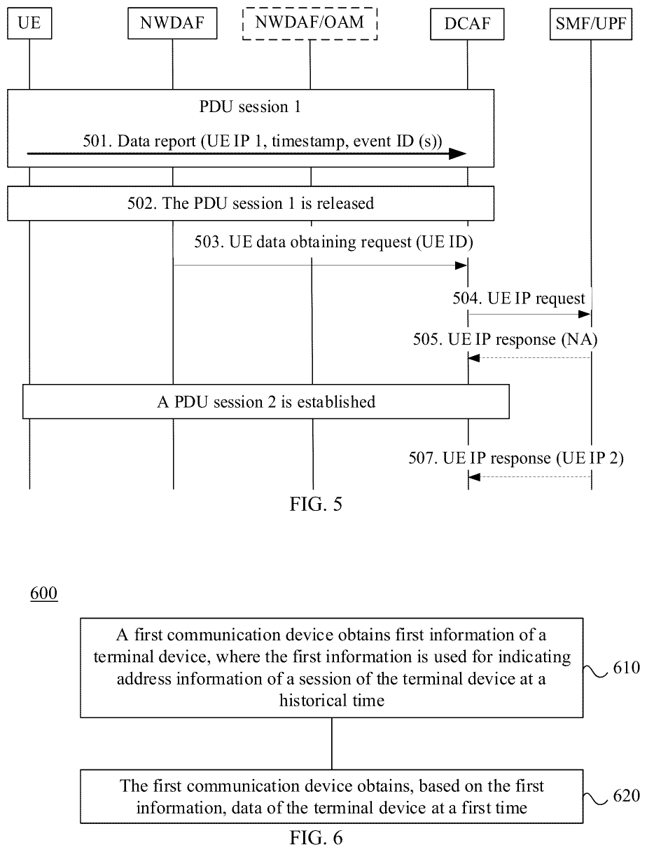

As a specific example, FIG. 5 shows an example of a communication process in the foregoing scenario, which may include the following step 501 to step 507.

501: The UE sends a data report to the DCAF, which includes a UE IP 1 address, a timestamp, an event ID/data type information, and the like.

The UE IP 1 address is a session used for uploading data, such as an IP address corresponding to a user plane PDU session 1.

502: The PDU session 1 is released.

For example, the PDU session 1 is released. After the PDU session 1 is released, the SMF/UPF may release a mapping relationship between the UE IP 1 address and the UE ID, and may allocate the IP1 address to another UE for use.

503: The NWDAF sends a UE data obtaining request to the DCAF.

504: The DCAF sends a UE IP request to the SMF/UPF.

Optionally, 505: The SMF/UPF sends a UE IP response to the DCAF, where the UE IP address is not available (NA).

506: The PDU session 2 is established.

Optionally, 507: The SMF/UPF sends the UE IP response to the DCAF, which includes a UE IP 2 address. The UE IP 2 address is an IP address corresponding to the newly established user plane PDU session 2.

Specifically, after the PDU session 1 is released, if the DCAF has a data obtaining request and obtains a UE IP address from the network (such as the SMF/UPF), according to the related technical procedure, either the network returns “not available” (corresponding to step 505) or returns the UE IP 2 address corresponding to the newly established PDU session (such as the PDU session 2) (corresponding to step 507).

If the UE IP response is returned as not available, the DCAF cannot obtain any data; and if the UE IP response return result is a new IP address, such as the UE IP 2 address, the DCAF can return only instant data corresponding to the UE IP 2 address. In either case, the DCAF does not know an IP address corresponding to the UE at the historical time, so the DCAF cannot obtain historical data corresponding to the UE IP 1 address at the historical time.

To solve the above technical problem, the embodiments of this application provide a data obtaining method and apparatus, a device, and a storage medium. Address information of a session in which the terminal device reports data to the first communication device is associated with a historical time, so that the first communication device can obtain data of the terminal device at a first time based on the address information of the session of the terminal device at the historical time, and therefore, the first communication device can obtain data corresponding to the address information of the session of the terminal device at the historical time. The first time overlaps with the historical time.

It should be noted that a type of the session is not limited in the embodiments of this application, for example, the session may be a user plane session or a data plane session. A type of the address information of the session is not limited in the embodiments of this application, for example, the address information may include an IP address or an Ethernet address.

The technical solutions of the embodiments of this application are described in detail below.

FIG. 6 is a schematic flowchart of a data obtaining method 600 according to an embodiment of this application. The data obtaining method 600 may be performed by the first communication device. As shown in FIG. 6, the data obtaining method 600 may include at least a part of the following step 610 to step 620.

610: The first communication device obtains first information of a terminal device, where the first information is used for indicating address information of a session of the terminal device at a historical time.

For example, the first communication device may include, but is not limited to, the DCAF, and the terminal device may be a terminal device that reports data to the first communication device, such as UE. There may be one or more terminal devices, which is not limited.

The session includes a session in which the terminal device reports data to the first communication device. In other words, the session is used when the terminal device reports data to the first communication device, or the session is used for the first communication device to collect user data, or the session is used for the first communication device to collect terminal device-related data, which is not limited in this application.

For example, the session may include a user plane session, or another type of session, such as a data plane session, which is not limited.

Optionally, in this embodiment of this application, the session of the terminal device may be corresponding to a specific data network name (DNN) and/or single network slice selection assistance information (S-NSSAI). The specific DNN and/or S-NSSAI may be deployed by the network specifically for collecting user data. Optionally, the session may also be referred to as a specific session, which is not limited in this application.

In an implementation, the session in this embodiment of this application refers to a session in which the terminal device reports data to the first communication device, that is, the specific session.

The address information of the session of the terminal device at the historical time may refer to address information allocated by the network for the session of the terminal device at the historical time. Because the address information corresponding to the session of the terminal device may change with time, address information of the session of the terminal device at different historical times may be obtained by associating the address information of the session of the terminal device with the historical time.

It should be noted that in this embodiment of this application, the address information of the session of the terminal device refers to address information corresponding to the session of the terminal device, that is, address information allocated to the terminal device for the session.

For example, the address information may include an IP address, an Ethernet address, or other types of address information, which is not limited. For example, if a session in the network is based on an IP address, the address information is an IP address; and if the session in the network is based on an Ethernet type, the address information is an Ethernet address. It should be understood that, in some embodiments of this application, an example in which the address information is an IP address is used for description, and the provided method is also applicable if the session in the network is based on other types of addresses (such as an address of an Ethernet type) instead of an IP address.

For example, one terminal device may correspond to one or more IP addresses at different historical times. The IP addresses at different historical times may correspond to different sessions of the terminal device.

In an implementation, the historical time may be a time point or a time period, which is not limited in this application.

In an implementation, the historical time may include a time when the network allocates the IP address to the terminal device and/or a time when the IP address is released, which is not limited in this application.

For example, a historical time associated with an IP address of a session of the terminal device may include any time point or time period in a process from establishment to release of the session, which is not limited in this application.

In an implementation, a historical time associated with an IP address of a session of the terminal device may be a period of time from establishment to release of the session, which is not limited in this application.

In some embodiments, step 610 may be implemented as follows.

The first communication device obtains the first information from a second communication device, where the first information includes historical time information and the address information of the session of the terminal device at the historical time. The historical time information is used for indicating the historical time.

For example, the second communication device may obtain the IP address of the session and the corresponding historical time information in the process from session establishment to release or after the session is released. The historical time information and the IP address of the session of the terminal device at the historical time are obtained, so that the IP address of the session of the terminal device can be correlated to the historical time.

Optionally, the second communication device may further associate the ID of the terminal device, the IP address of the session of the terminal device, and the historical time information, so that the historical time information may indicate a time when the IP address of the session of the terminal device is associated with the ID of the terminal device.

For example, the second communication device may be at least one of an SMF, a UPF, or an NWDAF.

As an example, when the second communication device is an SMF, the SMF may obtain an IP address allocated to the session of the terminal device from the SMF, or obtain an IP address allocated to the session of the terminal device from the UPF, which is not limited in this application.

For example, the IP address of the terminal device may be a private network IP address of the terminal device or a public network IP address of the terminal device, which is not limited. For example, when NAT is deployed in the network, the IP address of the terminal device is usually the public network IP address of the terminal device; and when NAT is not deployed in the network, the IP address of the terminal device is usually the private network IP address of the terminal device.

For example, the ID of the terminal device may be an SUPI or a GPSI of the terminal device, or another unique identifier of the terminal device, which is not limited in this application.

Optionally, the historical time information may include time information of establishment of the session and/or time information of release of the session. The time information of establishment of the session is information of a time when the IP address is allocated, and the time information of release of the session is information of a time when the IP address is released. The time information of establishment of the session can be understood as a time of session establishment, and the time information of release of the session can be understood as a time of session release.

As an example, the second communication device may obtain the IP address of the session, the ID of the terminal device, and corresponding time information T1 when the session of the terminal device is established (setup/establishment). The time information T1 may refer to a moment T1. The time information T1 may include the time information of establishment of the session.

For example, the time information T1 may be a moment when an IP address is allocated to the terminal device, or a moment when the terminal device obtains the IP address, or a time when an association relationship is established between the IP address of the session of the terminal device and the ID of the terminal device, which is not limited. In other words, at the moment T1, the association relationship is established between the IP address of the session of the terminal device and the ID of the terminal device.

As another example, the second communication device may obtain corresponding time information T2 when the session of the terminal device is released. The time information T2 may refer to a moment T2. The time information T2 may include the time information of release of the session. In other words, at the moment T2, the association relationship between the IP address of the terminal device and the ID of the terminal device is released.

Optionally, the second communication device may further receive a session establishment request from the terminal device. The session establishment request includes first indication information, such as a specific session indication, and the first indication information is used for indicating that the session requested to be established is used for the terminal device to report data to the first communication device.

When the session establishment request includes the first indication information and/or the session corresponds to the specific DNN and/or S-NSSAI, the second communication device may determine that the session is used for the terminal device to report data to the first communication device, and in this case, the second communication device may obtain the historical time information and the IP address corresponding to the historical time information. For example, the second communication device may obtain the IP address of the session of the terminal device, the ID of the terminal device, and the corresponding time information T1 of session establishment or time information T2 of session release.

After obtaining the IP address and the historical time information of the session of the terminal device at the historical time, the second communication device sends the IP address and the historical time information to the first communication device as the first information.

In some embodiments, step 610 may alternatively be implemented as follows.

The first communication device obtains the first information from a second communication device, where the first information includes an IP address corresponding to the terminal device at a time when the session is established.

Specifically, the second communication device may obtain, when the session used for the terminal device to report data to the first communication device is established, the IP address corresponding to the time when the session is established, and send the IP address to the first communication device as the first information. Correspondingly, the first communication device receives the IP address.

For example, the second communication device may be an SMF, a UPF, or the like, which is not limited.

In a possible implementation, the first information may further include second indication information, and the second indication information is used for indicating to the first communication device that the session is established, or is used for indicating that the IP address in the first information is allocated. Correspondingly, based on the second indication information, the first communication device may determine that the IP address in the first information is the IP address corresponding to the time when the session is established, or determine that the IP address in the first information is allocated.

In another possible implementation, when the first information does not include the second indication information, the protocol may predefine the IP address in the first information as the IP address corresponding to the time when the session is established. Alternatively, when receiving an IP address in the first information for the first time, the first communication device may determine that the IP address is the IP address corresponding to the time when the session is established.

Optionally, the first information may further include time information of establishment of the session. For example, the time information of establishment of the session may be the time information T1 above, which is not limited in this application.

Optionally, when the first information does not include the time information of establishment of the session, the first communication device may determine a time of receiving the first information as the time of session establishment. Correspondingly, the first communication device may record the time information of establishment of the session.

Optionally, the time information of establishment of the session herein may also be referred to as historical time information, which is not limited.

In some embodiments, step 610 may alternatively be implemented as follows.

The first communication device obtains the first information from a second communication device, where the first information includes an IP address corresponding to the terminal device at a time when the session is released.

Specifically, the second communication device may obtain, when the session used for the terminal device to report data to the first communication device is released, the IP address corresponding to the time when the session is established, and send the IP address to the first communication device as the first information. Correspondingly, the first communication device receives the IP address.

For example, the second communication device may be an SMF, a UPF, or the like, which is not limited.

In a possible implementation, the first information further includes third indication information, and the third indication information is used for indicating to the first communication device that the session is released, or is used for indicating that the IP address in the first information is released. Correspondingly, based on the third indication information, the first communication device may determine that the IP address in the first information is the IP address corresponding to the time when the session is released, or determine that the IP address in the first information is released.

In another possible implementation, when the first information does not include the third indication information, the protocol may predefine the IP address in the first information as the IP address corresponding to the time when the session is released. Alternatively, when receiving an IP address in the first information for the second time, the first communication device may determine that the IP address is the IP address corresponding to the time when the session is released.

Optionally, the first information may further include the time information of release of the session. For example, the time information of release of the session may be the time information T2 above, which is not limited in this application.

Optionally, when the first information does not include the time information of release of the session, the first communication device may determine a time of receiving the first information as the time of session release. Correspondingly, the first communication device may record the time information of release of the session.

Optionally, the time information of release of the session herein may also be referred to as historical time information, which is not limited.

In some possible implementations, the second communication device may actively send the first information to the first communication device when determining establishment/release of the session used for the terminal device to report data to the first communication device, or may send the first information to the first communication device as a response to a subscription request message of the first communication device.

In some embodiments, step 610 may alternatively be implemented as follows.

The first communication device sends a first request message to the second communication device, where the first request message includes first time information, and the first time information is used for indicating a first time; and the first communication device receives the first information from the second communication device, where the first information includes an IP address of the session of the terminal device at the first time.

Specifically, the second communication device may obtain the IP address corresponding to the first time information, and in response to the first request message sent by the first communication device, send the IP address of the session of the terminal device at the first time to the first communication device as the first information. For example, the IP address of the session of the terminal device at the first time may be referred to as a first IP address.

The first time overlaps with the historical time. For example, the first time overlaps with the historical time, which may indicate that the first time falls within a time period corresponding to the historical time, or the first time spans time periods corresponding to a plurality of historical times, or the first time overlaps with a time period corresponding to the historical time, which is not limited in this application.

For example, the first time overlaps with the time period corresponding to the historical time, that is, a part of the first time belongs to the historical time, and a part of the first time may belong to a current and/or future time. For example, the first time is a time period from last month to next two months.

Optionally, for data belonging to the current and/or future time in the first time of the terminal device, corresponding data may be obtained based on an IP address of an instant session of the terminal device, which is not limited in this application.

In a possible case, the second communication device may store IP addresses of the terminal device at a plurality of different historical times, where the IP addresses at different historical times may correspond to sessions of the terminal device at different historical times. After receiving the first request message, the second communication device may send the IP address corresponding to the historical time including the first time to the first communication device as the IP address of the session of the terminal device at the first time.

The IP address of the session of the terminal device at the first time may be one IP address of the session of the terminal device at one historical time at which the first time falls, or a plurality of IP addresses corresponding to a plurality of historical times that the first time spans, or an IP address corresponding to an overlapping part between the historical time and the first time.

For example, the first request message may include at least one of the ID of the terminal device and condition information #2. The ID and the condition information #2 of the terminal device are from the second request message sent by the consumer device to the first communication device. Specifically, for the ID and the condition information #2 of the terminal device, refer to the following description of the second request message.

For example, the second communication device may be an SMF, a UPF, or an NWDAF, which is not limited.

As an example, when the second communication device is an NWDAF, the NWDAF may obtain the IP address of the session of the terminal device at the historical time from the SMF/UPF. Optionally, the NWDAF may send a subscription request message to the SMF/UPF, to obtain the IP address of the session of the terminal device at the historical time. Optionally, the NWDAF may further obtain the historical time information from the SMF/UPF.

In some embodiments, the first communication device may further send a subscription request message to the second communication device, to obtain the first information of the terminal device. In response to the subscription request message, the second communication device may send the first information to the first communication device when obtaining the first information.

Optionally, the subscription request message may include at least one of the ID of the terminal device and condition information #1.

The ID of the terminal device may indicate a subscribed object terminal. The object terminal herein may refer to one or some specific terminal devices, and may alternatively be any terminal device, which is not limited.

The condition information #1 is used for defining a scope of the object terminal. For example, the scope may be an area scope, such as tracking areas (TAs), cells, or a geographical area (such as a latitude and longitude area), and the scope may alternatively be a specific location, such as a TA ID, a cell ID, or a latitude and longitude. Optionally, the scope may alternatively be a time scope. The condition information #1 may be set to indicate the second communication device to obtain only an IP address of a session of a terminal device in a corresponding area or location when reporting data, or to obtain only an IP address of a session of a terminal device in a specific time period when reporting data.

Optionally, the subscription request message may further include an event identifier (event ID), which is specifically used for indicating that the requested event/data is an IP address of a corresponding session returned when the terminal device reports data to the first communication device. The event identifier may also be referred to as data type information.

Therefore, through the interaction process between the first communication device and the second communication device, the first communication device may learn of and record the IP address of the session used by the terminal device at the historical time for reporting data to the first communication device, such as learning of and recording that the IP address of the session of the terminal device is associated with the ID of the terminal device during the time period from the moment T1 to the moment T2, or recording the IP address of the session of the terminal device at the first time, or recording the corresponding IP address of the session of the terminal device at the time of session establishment, or recording the corresponding IP address of the session of the terminal device at the time of session release, which is not limited.

620: The first communication device obtains, based on the first information, data of the terminal device at the first time.

Specifically, the first communication device may obtain, based on the first information, the address information of the session of the terminal device at the historical time, and may further obtain, based on the address information at the historical time, the data of the terminal device at the first time.

Therefore, in this embodiment of this application, the address information of the session in which the terminal device reports data to the first communication device is associated with the historical time, so that the first communication device can obtain the data of the terminal device at the first time based on the address information of the session of the terminal device at the historical time, and therefore, the first communication device can obtain the data corresponding to the address information of the session of the terminal device at the historical time.

In some embodiments, the first communication device may prestore data reported by the terminal device at the historical time, and then obtain, based on the first information, the data of the terminal device at the first time from the data reported by the terminal device at the historical time. The data reported by the terminal device at the historical time is reported through the session mentioned above. In this embodiment of this application, the data reported by the terminal device at the historical time may be referred to as first data.

For example, the first data is associated with an IP address of a corresponding session. For example, when the terminal device reports first data #1 to the first communication device through a session #1 at a first historical time, the first data #1 is associated with an IP address #1 of the session #1. For another example, when the terminal device reports first data #2 to the first communication device through a session #2 at a second historical time, the first data #2 is associated with an IP address #2 of the session #2.

Optionally, the terminal device may send the first data and the associated IP address to the first communication device through the session. Correspondingly, the first communication device receives the first data and the associated IP address through the session.

For example, the terminal device may report a data packet including the first data and the IP address to the first communication device. In a possible implementation, the data packet may be in a packet format, where the first data may be included in a payload of the data packet, and the IP address may be included in a packet header of the data packet, which is not limited in this application.

For example, the IP address sent by the terminal device to the first communication device may be a private network IP address of the terminal device. Optionally, when the network deploys network address translation (NAT), the private network IP address is converted into a public network IP address of the terminal device after NAT, to be sent to the first communication device.

Optionally, the terminal device may further send a timestamp of the first data to the first communication device. In a possible implementation, the timestamp may be carried in a data packet (such as a payload) including the first data, which is not limited in this application. For example, the timestamp may include at least one of a sampling timestamp of the first data and a reporting timestamp of the first data.

In some embodiments, after receiving the first data reported by the terminal device, the first communication device may store the first data.

In a possible implementation, the first communication device may store the first data by using an IP address of the terminal device as an index. For example, the IP address may be an IP address carried in the data packet reported by the terminal device to the first communication device.

In another possible implementation, the first communication device may alternatively store the first data by using an ID of the terminal device as an index. For example, the first communication device may map the IP address associated with the first data to the ID of the terminal device based on the stored association relationship between the IP address of the session of the terminal device and the ID of the terminal device, and then store the first data by using the ID of the terminal device as an index.

In another possible implementation, the first communication device may alternatively store the first data by using both the IP address and the ID of the terminal device as indexes.

Optionally, when storing the first data, the first communication device may further store a timestamp of the first data. For example, the timestamp may include at least one of the following: a sampling timestamp of the first data, a reporting timestamp of the first data, a timestamp of the first data arriving at the first communication device, a timestamp of the first data stored by the first communication device, and the like.

In some embodiments, the first communication device may determine the first IP address of the session of the terminal device at the first time based on the first information, and then obtain the data of the terminal device at the first time based on the first IP address.

In a possible implementation, when the first information includes the historical time information and the IP address of the session of the terminal device at the historical time, the first communication device may obtain an IP address corresponding to the first time information from the IP address of the session of the terminal device at the historical time as the first IP address. The first time information is used for indicating the first time. Specifically, for the first time, refer to the above description.

For example, when the historical time information included in the first information indicates a plurality of historical time periods, an IP address corresponding to a historical time period within which the first time falls is the first IP address, or a plurality of IP addresses corresponding to a plurality of historical time periods that the first time spans are the first IP addresses, or an IP address corresponding to an overlapping part between the historical time period and the first time is the first IP address.

In another possible implementation, when the first information includes the IP address (namely, the first IP address) of the session of the terminal device at the first time, the IP address included in the first information may be directly used as the first IP address.

In some embodiments, when the first communication device stores data by using the IP address as an index (or by using both the IP address and the ID of the terminal device as indexes), data corresponding to the first IP address may be retrieved from the data as the data of the terminal device at the first time.

Therefore, when having a data obtaining requirement of the first time, the first communication device can obtain the data of the terminal device at the first time by obtaining the first IP address of the session of the terminal device at the first time, and retrieving the data corresponding to the first IP address from the stored data.

In some embodiments, when the first communication device stores data by using the ID of the terminal device (or by using both the IP address and the ID of the terminal device) as an index, the first communication device may obtain data corresponding to the ID of the terminal device at the first time. For example, the first communication device may retrieve the data corresponding to the ID of the terminal device at the first time from the stored data.

Therefore, by storing the first data by using the ID of the terminal device as the index, the first communication device can retrieve the data corresponding to the ID of the terminal device at the first time from the stored data when having a data obtaining requirement of the first time, thereby obtaining the data of the terminal device at the first time. In this case, the first communication device may not need to obtain the IP address of the session of the terminal device at the first time, thereby being beneficial to improving efficiency of data obtaining.

In some embodiments, the first communication device may further receive a second request message sent by a consumer device, where the second request message includes first time information, and the second request message is used for obtaining the data of the terminal device at the first time. For example, the second request message may also be referred to as a data obtaining request (UE data collection request), which is not limited. Then, the first communication device may send a response message to the consumer device, and the response message includes the data of the terminal device at the first time.

For example, for the first time, refer to the above description.

For example, the consumer device may be a device, such as an NWDAF, an AF, or a RAN, that has a requirement of obtaining the data of the terminal device, which is not limited in this application.

As some examples, the second request message may be used for requesting data of one terminal device in one historical time period, or data of one terminal device in a plurality of historical time periods, or data of a plurality of terminal devices in one or more historical time periods respectively, which is not limited.

In a possible implementation, the second request message may include at least one of the ID of the terminal device and condition information #2, and the condition information #2 is used for indicating a condition that the terminal device meets.

For example, the ID of the terminal device herein may be an SUPI or a GPSI, which is not limited. In an implementation, when a terminal device identifier of the second terminal device is an SUPI, it may be converted into a GPSI before being sent to the first communication device.

For example, the condition information #2 is used for defining a scope of the terminal device. For example, the scope may be an area scope, such as tracking areas (TAs), cells, or a geographical area (such as a latitude and longitude area), and the scope may alternatively be a specific location, such as a TA ID, a cell ID, or a latitude and longitude. The condition information #2 may be set to request the first communication device to return data of the terminal device in a corresponding area or location at the first time.

Optionally, the first communication device may obtain, based on the condition information #2, a terminal device ID list of at least one terminal device that meets the condition.

Optionally, when the second request message includes the condition information #2, the first request message may not include the ID of the terminal device.

Therefore, after obtaining the second request message, the first communication device may obtain the first time information and the ID of the terminal device based on the second request message, to obtain the first information, such as the IP address of the corresponding terminal device at the first time or the IP address at the historical time, based on the first time information and the ID of the terminal device, and further obtain the data of the terminal device at the first time based on the first information.

In another possible implementation, the second request message may include the IP address of the session of the terminal device at the first time.

For example, before sending the second request message to the first communication device, the consumer device may obtain the IP address of the session of the terminal device at the first time, and then send the second request message carrying the IP address to the first communication device, to request data corresponding to the IP address. The data corresponding to the IP address is the data of the session of the terminal device at the first time.

In a possible case, when the NWDAF stores the IP address of the session of the terminal device at the historical time, the consumer device may send a third request message to the NWDAF, to request the IP address of the session of the terminal device at the first time. In response to the third request message, the NWDAF sends the IP address of the session of the terminal device at the first time to the consumer device. When the consumer device is the NWDAF device, the IP address of the session of the terminal device at the first time may be obtained from the NWDAF device through an internal operation.

Herein, a function of the third request message is similar to that of the first request message above, and both are used for requesting the IP address of the session of the terminal device at the first time. For details, refer to the related description of the first request message, which is not described herein again.

Therefore, the IP address of the terminal device at the first time is carried in the second request message, so that the first communication device may obtain the data of the terminal device at the first time based on the IP address of the terminal device at the first time. In this case, the first communication device does not need to find the IP address at the first time from the IP address of the session of the terminal device at the historical time, thereby being beneficial to improving efficiency of data obtaining.

In some other embodiments, the terminal device may store the data and the IP address of the terminal device at the historical time, such as storing the data at the historical time by using the IP address or the ID of the terminal device as an index. Optionally, the terminal device may further store time information corresponding to the data. In this case, the first communication device may request, based on the first information, data of the terminal device at the first time from the terminal device.

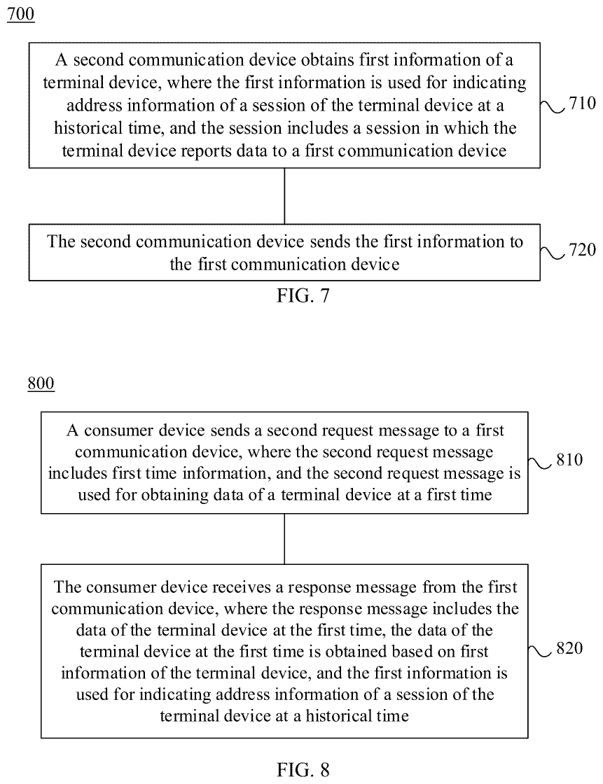

FIG. 7 is a schematic flowchart of another data obtaining method 700 according to an embodiment of this application. The data obtaining method may be performed by a second communication device. As shown in FIG. 7, the data obtaining method 700 may include at least a part of the following step 710 and step 720.

710: The second communication device obtains first information of a terminal device, where the first information is used for indicating address information of a session of the terminal device at a historical time, and the session includes a session in which the terminal device reports data to a first communication device.

720: The second communication device sends the first information to the first communication device.

For example, the first communication device may include, but is not limited to, a DCAF, and the terminal device may be a terminal device that reports data to the first communication device.

For example, the second communication device may include, but is not limited to, an SMF, a UPF, or an NWDAF.

In some embodiments, the first information may include historical time information and the address information of the session of the terminal device at the historical time. The historical time information is used for indicating the historical time.

It should be understood that, in some embodiments of this application, an example in which the address information is an IP address is used for description, and the provided method is also applicable if the session in the network is based on other types of addresses (such as an address of an Ethernet type) instead of an IP address.

Optionally, the historical time information may include time information of establishment of the session and/or time information of release of the session.

As an example, when the second communication device is an SMF or a UPF, the second communication device may obtain the IP address of the session of the terminal device at the historical time as the first information, and send the first information to the first communication device. Optionally, the first information may further include historical time information. For example, the second communication device may obtain the first information during session establishment or session release or after session release.

In some embodiments, step 710 may be specifically implemented as follows.

The second communication device receives a first request message from the first communication device, where the first request message includes first time information, and the first time information is used for indicating the first time; and the second communication device determines an IP address of the session of the terminal device at the first time as the first information. That is, the first information may include the IP address of the session of the terminal device at the first time.

As an example, when the second communication device is an SMF/UPF, the second communication device may obtain the IP address of the session of the terminal device at the historical time, when receiving the first request message from the first communication device, obtain the IP address at the first time from the IP address of the session of the terminal device at the historical time based on the first time information, and send the IP address at the first time to the first communication device as the first information.

As another example, when the second communication device is an NWDAF, the second communication device may obtain the IP address of the session of the terminal device at the historical time from the SMF/UPF. When receiving the first request message from the first communication device, the NWDAF may obtain the IP address at the first time from the IP address of the session of the terminal device at the historical time based on the first time information, and send the IP address at the first time to the first communication device as the first information.

In some embodiments, step 710 may be specifically implemented as follows.

The second communication device receives a session establishment request message from the terminal device, where the session establishment request message is used for establishing a session in which the terminal device reports data to the first communication device; and the second communication device determines an IP address of the terminal device at a time when the session is established as the first information. In other words, the first information may include the IP address corresponding to the terminal device at a time when the session is established.

Optionally, the session establishment request message may include first indication information, and the first indication information is used for indicating that the established session is used for the terminal device to report data to the first communication device. In other words, the first indication information is used for indicating establishment of the session in which the terminal device reports data to the first communication device.

When the session establishment request message includes the first indication information, the second communication device may determine that the session establishment request is used for requesting establishment of the session used for the terminal device to report data to the first communication device.

In some other embodiments, when the session corresponds to the specific DNN and/or S-NSSAI, the second communication device may also determine that the session is the session used for the terminal device to report data to the first communication device, which is not limited in this application.

Optionally, the first information may further include second indication information, and the second indication information is used for indicating to the first communication device that the session is established, or is used for indicating that the IP address in the first information is allocated. Correspondingly, based on the second indication information, the first communication device may determine that the IP address in the first information is the IP address corresponding to the time when the session is established, or determine that the IP address in the first information is allocated.

When the first information does not include the second indication information, the protocol may predefine the IP address in the first information as the IP address corresponding to the time when the session is established. Alternatively, when receiving an IP address in the first information for the first time, the first communication device may determine that the IP address is the IP address corresponding to the time when the session is established.

Optionally, the first information may further include time information of establishment of the session. For example, the time information of establishment of the session may be the time information T1 above, which is not limited in this application.

Optionally, when the first information does not include the time information of establishment of the session, the first communication device may determine a time of receiving the first information as the time of session establishment.

In some embodiments, step 710 may be specifically implemented as follows.

The second communication device receives a session release request message from the terminal device, where the session release request is used for releasing the session in which the terminal device reports data to the first communication device; and the second communication device determines an IP address corresponding to the terminal device at a time when the session is released as the first information. In other words, the first information may include the IP address corresponding to the terminal device at a time when the session is released.

Optionally, the first information may further include third indication information, and the third indication information is used for indicating to the first communication device that the session is released, or is used for indicating that the IP address in the first information is released. Correspondingly, based on the third indication information, the first communication device may determine that the IP address in the first information is the IP address corresponding to the time when the session is released, or determine that the IP address in the first information is released.

When the first information does not include the third indication information, the protocol may predefine the IP address in the first information as the IP address corresponding to the time when the session is released. Alternatively, when receiving an IP address in the first information for the second time, the first communication device may determine that the IP address is the IP address corresponding to the time when the session is released.

Optionally, the first information may further include the time information of release of the session. For example, the time information of release of the session may be the time information T2 above, which is not limited in this application.

Optionally, when the first information does not include the time information of release of the session, the first communication device may determine a time of receiving the first information as the time of session release.

In some embodiments, the second communication device may further receive a subscription request message from the first communication device, and the subscription request message is used for obtaining the first information of the terminal device. In response to the subscription request message, the second communication device may send the IP address of the session of the terminal device at the historical time to the first communication device as the first information. For example, in this embodiment, the second communication device includes, but is not limited to, an SMF or a UPF.

In some embodiments, the second communication device may further send a subscription request message to a third communication device, and the subscription request message is used for obtaining the first information of the terminal device. For example, in this embodiment, when the second communication device may be an NWDAF, the third communication device may include, but is not limited to, an SMF or a UPF. In response to the subscription request message, the SMF/UPF may send the first information of the terminal device to the NWDAF.

In some embodiments, the subscription request message may include an ID of a target terminal device or condition information, and the condition information is used for indicating a condition that the target terminal device meets.

In some embodiments, the first information further includes an ID of the terminal device.

It should be understood that content in the data obtaining method 700 corresponds to all or a part of content in the data obtaining method 600, and for similar description, refer to the embodiment of the method 600. To avoid repetition, details are not described herein again.

Therefore, in this embodiment of this application, the address information of the session in which the terminal device reports data to the first communication device is associated with the historical time, so that the first communication device can obtain the data of the terminal device at the first time based on the address information of the session of the terminal device at the historical time, and therefore, the first communication device can obtain the data corresponding to the address information of the session of the terminal device at the historical time.

FIG. 8 is a schematic flowchart of another data obtaining method 800 according to an embodiment of this application. The data obtaining method 800 may be performed by a consumer device. As shown in FIG. 8, the data obtaining method 800 may include at least a part of the following step 810 and step 820.

810: The consumer device sends a second request message to a first communication device, where the second request message includes first time information, and the second request message is used for obtaining data of a terminal device at a first time.

820: The consumer device receives a response message from the first communication device, where the response message includes the data of the terminal device at the first time. The data of the terminal device at the first time is obtained based on first information of the terminal device, and the first information is used for indicating address information of a session of the terminal device at a historical time.

Therefore, in this embodiment of this application, the address information of the session in which the terminal device reports data to the first communication device is associated with the historical time, so that the first communication device can obtain the data of the terminal device at the first time based on the address information of the session of the terminal device at the historical time, and therefore, the first communication device can obtain the data corresponding to the address information of the session of the terminal device at the historical time.

In some embodiments, the second request message may include an identifier of the terminal device or first condition information, and the first condition information is used for indicating a condition that the terminal device meets.

In some embodiments, the second request message includes address information of the session of the terminal device at the first time.

It should be understood that content in the data obtaining method 800 corresponds to all or a part of content in the data obtaining method 600 or the data obtaining method 700, and for similar description, refer to the embodiments of the method 600 or the method 700. To avoid repetition, details are not described herein again.

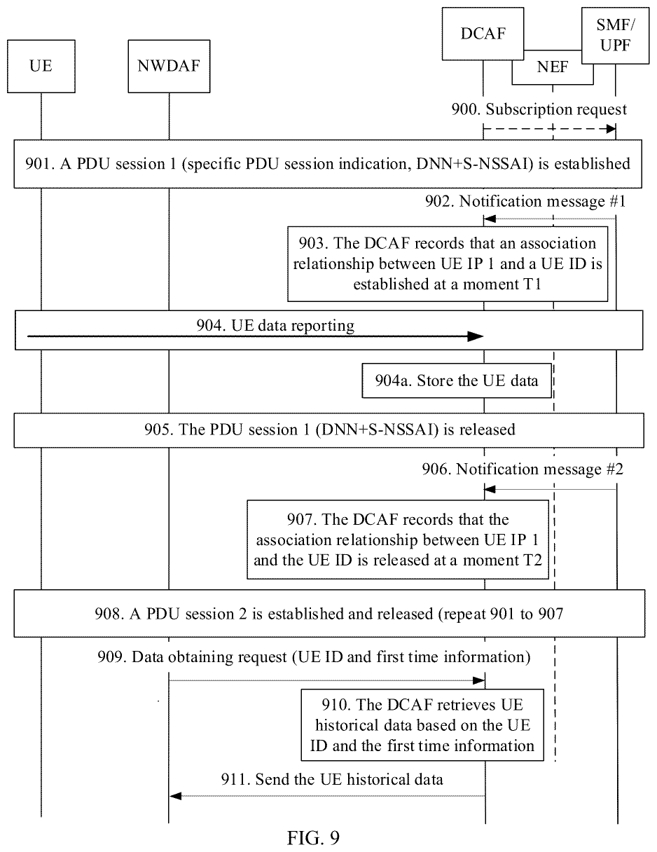

Several specific examples provided in this embodiment of this application will be described below with reference to FIG. 9 to FIG. 11. Specifically, an example in which the first communication device is a DCAF, the terminal device is UE, the session is a PDU session, and the address information is an IP address is used below for description. In the following embodiments, the described IP, IP address, UE IP, UE IP address, and the like represent the same meaning.

FIG. 9 is a schematic flowchart of a data obtaining method according to an embodiment of this application. A second communication device is an SMF or a UPF, and a consumer device is an NWDAF. The SMF or the UPF may send an IP address of a session of a terminal device at a historical time to a DCAF. The following describes the data obtaining method with reference to FIG. 9.

It should be noted that when the DCAF communicates with a device in a network (such as the SMF/UPF) in this embodiment of this application, if the DCAF is an untrusted AF, it may need to be transferred or converted through an NEF. For example, the NEF may realize conversions such as: between external and internal geographic areas, between external and internal UE identifiers, and between external data and internal network time references, which is not limited.

Optionally, 900: The DCAF sends a subscription request to the SMF/UPF.

Specifically, the DACF sends the subscription request to the SMF/UPF, to obtain first information of UE, and the first information is used for indicating an IP address of a PDU session of the UE at a historical time. For example, the first information may include the IP address of the session of the terminal device at the historical time.

For example, the session may be a user plane PDU session, which is not limited in this application. For convenience, the following uses an example in which the session is a PDU session for description.

For example, the subscription request may include at least one of the following pieces of information:
an event ID or data type information: used for indicating that a subscribed event or data is an IP address corresponding to a session used by the terminal device when reporting data to the DCAF;
target UE information: used for indicating a subscribed target object terminal, where the object may be one or some specific UEs (such as a UE ID) or any terminal (that is, any UE); and
condition information (filter) #1: used for defining a scope of the object terminal, where the scope may be an area scope (such as TAs Cells or a geographic area of latitude and longitude) or a location (such as a TA ID, a cell ID, or a geographic location of latitude and longitude) used for indicating that only an IP address corresponding to a session of a terminal in the area or location when reporting data is obtained; and the scope may also be a time scope used for indicating that an IP address corresponding to a session of the terminal when reporting data within a specific time period is obtained.

Specifically, the subscription request is an example of the subscription request message above, and for details, refer to the related description above.

901: A PDU session 1 is established.

Specifically, the UE may initiate an establishment process of the PDU session 1, and the PDU session is used for the UE to report data to the DCAF.

Optionally, the PDU session 1 may correspond to a specific DNN and/or S-NSSAI, where the DNN and/or S-NSSAI are/is deployed by the network specifically for collecting user data.

Optionally, when the UE sends a PDU session establishment request to the SMF/UPF, first indication information may be carried to indicate that the PDU session for which the establishment is requested (such as the PDU session 1) is used for the terminal device to report data to the DCAF. For example, the first indication information may be used for indicating to the SMF/UPF that the PDU session 1 for which the establishment is requested is used for the terminal device to report data to the DCAF. The first indication information may also be referred to as specific PDU session indication information.

Specifically, the PDU session establishment request is an example of the session establishment request above, and for details, refer to the related description above.

After receiving the PDU session establishment request of the UE, the SMF/UPF may send first information of the UE to the DCAF if it is determined that the established PDU session 1 is used for the UE to report data to the DCAF, where the first information may indicate an IP address of the PDU session 1 of the UE at the historical time. For example, the first information may be carried in a notification message #1 and/or a notification message #2.

902: The SMF/UPF sends the notification message #1 to the DCAF.

In some embodiments, the notification message #1 may include the IP address of the PDU session 1 at the historical time (such as UE IP 1). For example, the historical time may include a time when the PDU session 1 is established, which is not limited.

The IP address may be a private network IP address of the UE or a public network IP address of the UE, which is not limited. When NAT is deployed in the network, the IP address herein is usually the public network IP address of the UE; and when NAT is not deployed in the network, the IP address is usually the private network IP of the UE. Before the SMF/UPF sends the public network IP address of the UE to the DCAF, the SMF may obtain the public network IP address of the UE from the public network IP address of the UE obtained by the SMF or from the UPF.

Optionally, the notification message #1 may further include historical time information. As an example, the historical time information may include time information (for example, time information T1) of establishment of the PDU session 1, to indicate the time when the PDU session 1 is established. As another example, the historical time information may include time information that the IP address of the PDU session 1 is allocated, to indicate a time when the IP address of the PDU session 1 is allocated.

Optionally, the notification message #1 may further include second indication information for indicating to the DCAF that the PDU session 1 is established.

Optionally, the notification message #1 may further include a UE ID. The UE ID may be a UE SUPI or a GPSI, which is not limited.

It should be noted that the SMF/UPF may send the notification message #1 to the DCAF when it is determined that a specific PDU session is established, which may be actively sent by the SMF/UPF to the DCAF, or sent as a response to the subscription request in step 900, which is not limited in this application. The SMF/UPF may determine establishment of the specific PDU session when the PDU session establishment request includes the specific PDU session indication information, or the PDU session corresponds to the specific DNN and/or S-NSSAI.

903: The DCAF records that an association relationship between UE IP 1 and the UE ID is established at a moment T1.

Specifically, the DCAF may obtain an IP address corresponding to a time of session establishment of the PDU session 1 of the terminal device from the notification message #1, such as UE IP 1. After receiving the notification message #1, the DCAF may record that the association relationship between UE IP 1 and the UE ID is established at the moment T1.

In some embodiments, the time information T1 may be obtained from the notification message #1.

In some other embodiments, when the notification message #1 does not include the historical time information, the DCAF may determine a moment at which UE IP 1 corresponding to the time of establishment of the PDU session 1 is received (such as a moment at which the notification message #1 is received) as the moment T1.

904: The UE reports UE data to the DCAF.

Specifically, the UE reports the UE data to the DCAF through the PDU session 1. For example, the UE may report a specific data type to the DCAF, and the data may be reported to the DCAF through the specific PDU session (such as the PDU session 1) in this embodiment of this application.

For example, the data reported by the UE may include data and a UE IP address (such as UE IP 1). Optionally, the data reported by the UE may further include a timestamp. For example, the UE may report a data packet to the DCAF, which includes reported data.

The IP address in the data reported by the UE is usually a private network IP address of the UE. If the network is deployed with an NAT mechanism, the private network IP address of the UE is converted into a public network IP of the UE after NAT, and then is sent to the DCAF.

904a: The DCAF stores the UE data.

Specifically, after receiving the data reported by the UE, the DCAF may store the data reported by the UE.

In some embodiments, when storing the data reported by the UE, the DCAF may further record timestamp information corresponding to the data, and the timestamp information may include at least one of the following pieces of information: a timestamp of UE data sampling, a timestamp of UE data reporting, a timestamp of data arriving at the DCAF, and a timestamp of data stored by the DCAF.

In a possible implementation, the DCAF may store the data reported by the UE by using the UE IP address as an index. The UE IP address is an IP address carried in the data reported by the UE to the DCAF.

In another possible implementation, the DCAF may store the data reported by the UE by using the UE ID as an index. The UE ID is derived from the association relationship between the UE ID and the UE IP established by the DCAF in step 903. For example, the DCAF may map the UE IP to the UE ID based on the association relationship, and further store, by using the UE ID as an index, the data reported by the UE.

In another possible implementation, the DCAF may store the data reported by the UE by using both the UE IP and the UE ID as indexes.

905: The PDU session 1 is released.

Specifically, the UE may initiate release of the PDU session 1, for example, sending a PDU session release request message to the SMF/UPF. The PDU session release request message is used for requesting release of the PDU session 1. In response to the PDU session release request message, the SMF/UPF releases the PDU session 1.

906: The SMF/UPF sends the notification message #2 to the DCAF.

In some embodiments, the notification message #2 may include the IP address of the PDU session 1 at the historical time (such as UE IP 1). For example, the historical time may include a time when the PDU session 1 is released, which is not limited.

Optionally, the notification message #2 may further include historical time information. As an example, the historical time information may include time information of release of a PDU session 2 (such as time information T2), to indicate a time when the PDU session 2 is released. As another example, the historical time information may include time information that the IP address of the PDU session 1 is released, to indicate a time when the IP address of the PDU session 1 is released.

Optionally, the notification message #2 may further include third indication information for indicating to the DCAF that the PDU session 1 is released.

Optionally, the notification message #2 may further include a UE ID. The UE ID may be a UE SUPI or a GPSI, which is not limited.

It should be noted that the SMF/UPF may send the notification message #2 to the DCAF when it is determined that a specific PDU session is released, which may be actively sent by the SMF/UPF to the DCAF, or sent as a response to the subscription request in step 900, which is not limited in this application. The SMF/UPF may determine release of the specific PDU session when the PDU session release request includes the specific PDU session indication information, or the PDU session corresponds to the specific DNN and/or S-NSSAI.

907: The DCAF records that the association relationship between UE IP 1 and the UE ID is released at a moment T2.

Specifically, the DCAF may obtain an IP address corresponding to a time of session release of the PDU session 1 of the terminal device from the notification message #2, such as UE IP 1. After receiving the notification message #2, the DCAF may record that the association relationship between UE IP 1 and the UE ID is released at the moment T2.

In some embodiments, the time information T2 may be obtained from the notification message #2.

In some other embodiments, when the notification message #2 does not include the historical time information, the DCAF may determine a moment at which UE IP 1 corresponding to the time of release of the PDU session 1 is received (such as a moment at which the notification message #2 is received) as the moment T2.

Through the above step 903 and step 907, the DCAF may learn of and record that an association relationship exists between UE IP 1 and the UE ID in a time period from T1 to T2.

908: The PDU session 2 is established and released (repeat 901 to 907).

Specifically, establishment and data reporting processes of other PDU sessions of the UE, or establishment and data reporting processes of PDU sessions of other UEs are similar to the above step 901 to step 907.

At this point, the DCAF may store a large number of mapping relationships between the IP address of the UE and the UE ID in historical times, and the DCAF stores a large amount of data reported by the UE. The data is stored by using the UE ID as an index, is stored by using the UE IP as an index, or is stored by using both the UE ID and the UE IP as indexes. Optionally, the DCAF may further store time information (for example, a timestamp) corresponding to the data.

909: The NWDAF sends a data obtaining request message to the DCAF.

For example, as a consumer entity, the NWDAF sends the data obtaining request message (UE data collection request) to the DCAF, and the data obtaining request message may be used for requesting the data of the UE at the first time. The first time may include one or more historical times. The historical time overlaps with the first time. For example, the first time may fall within a time period corresponding to the historical time in the first information, or the first time may span time periods corresponding to a plurality of historical times in the first information, or the first time overlaps with a time period corresponding to one or more historical times in the first information.

The data obtaining request message may include first time information, and the first time information is used for indicating the first time.

Optionally, the data obtaining request message may include the UE ID and/or the condition information #2, where the condition information #2 is used for indicating a condition that the terminal device meets.

For example, the UE ID may be an SUPI or a GPSI. When the UE ID is the GPSI, it may be converted into a GPSI first and then sent to the DCAF.

For example, the condition information #2 may be used for defining a scope of the UE, where the scope may be an area scope (such as TAs Cells or a geographic area of latitude and longitude) or a location (such as a TA ID, a cell ID, or a geographic location of latitude and longitude) used for indicating that only reporting data of a terminal in the area or location is obtained. Correspondingly, the DCAF may obtain a corresponding UE ID (such as a UE ID list) based on the condition information #2.

For example, the UE data collection request may be an example of the second request message mentioned above, and for details, refer to the related description above.

910: The DCAF retrieves UE historical data based on the UE ID and the first time information.

Specifically, the DCAF may obtain, based on the data obtaining request message, a historical time period corresponding to the UE ID and the first time information, and then retrieve, based on the UE ID and the historical time period, the UE historical data from the data reported by the UE, that is, the data of the UE at the first time. The historical time period is an example of the first time.

In an implementation, if the DCAF stores the data by using the UE ID as an index (or using both the UE ID and the UE IP as indexes), the DCAF may directly retrieve the UE historical data from the stored data based on the UE ID and the time information obtained based on the data obtaining request.

In another implementation, if the DCAF stores the data by using the UE IP as an index (or using both the UE ID and the UE IP as indexes), the DCAF may first map, based on a correspondence between the UE ID and the UE IP in the historical time period, the UE ID obtained based on the data obtaining request to the UE IP, and then retrieve the UE historical data from the stored data based on the UE IP.

911: The DCAF sends the UE historical data to the NWDAF.

For example, the DCAF may send the UE historical data to the NWDAF as a response to the data obtaining request in step 909.

Therefore, in this embodiment of this application, the SMF/UPF sends, to the DCAF, the IP address of the PDU session in which the UE reports data, so that the DCAF records the IP address of the PDU session in which the UE reports data at the historical time. In this way, the DCAF may obtain the data of the UE at the first time based on the IP address that is of the PDU session of the UE at the historical time and that is stored in advance. Therefore, in this embodiment of this application, the DCAF can obtain the data corresponding to the IP address of the PDU session of the UE at the historical time.

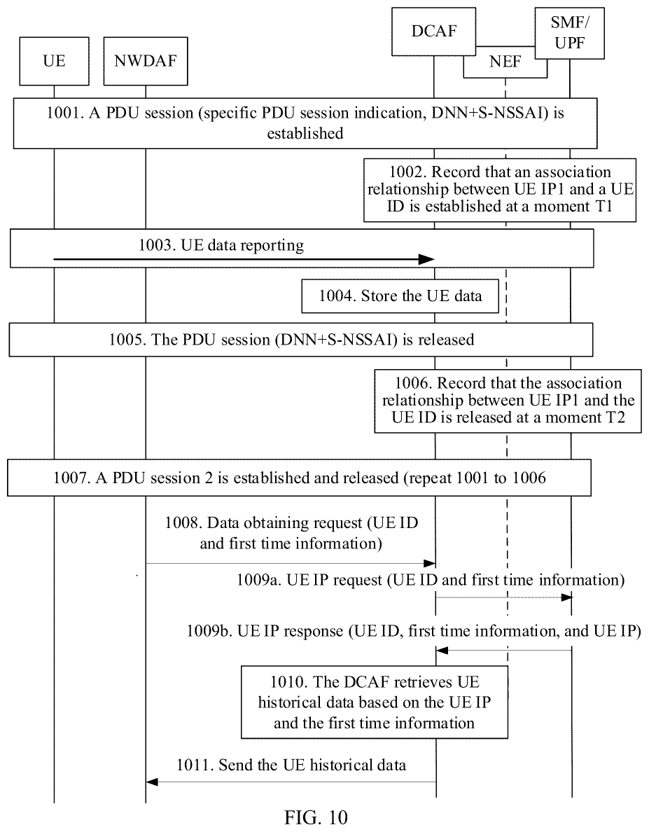

FIG. 10 is a schematic flowchart of another data obtaining method according to an embodiment of this application. A second communication device is an SMF or a UPF, and a consumer device is an NWDAF. The SMF or the UPF may locally store an IP address of a session of a terminal device at a historical time. The following describes the data obtaining method with reference to FIG. 10.

It should be noted that when the DCAF communicates with a device in a network (such as the SMF/UPF) in this embodiment of this application, if the DCAF is an untrusted AF, it may need to be transferred or converted through an NEF. For example, the NEF may realize conversions such as: between external and internal geographic areas, between external and internal UE identifiers, and between external data and internal network time references, which is not limited.

1001: A PDU session 1 is established.

Specifically, step 1001 is similar to step 901 in FIG. 9, and for details, refer to the description in FIG. 9.

After receiving the PDU session establishment request of the UE, the SMF/UPF may determine first information of the terminal device if it is determined that the established PDU session 1 is used for the UE to report data to the DCAF, where the first information may indicate an IP address of the PDU session 1 of the UE at the historical time.

For example, the first information may include the IP address of the PDU session 1 of the UE at the historical time. Optionally, the first information may further include historical time information. The historical time information may include time information (such as a moment T1) of establishment of the PDU session and/or time information (such as a moment T2) of release of the PDU session.

1002: The SMF/UPF records that an association relationship between UE IP 1 and a UE ID is established at the moment T1.

For example, the SMF/UPF may obtain and record historical time information T1 and the IP address of the PDU session 1 at the historical time T1 (such as UE IP 1). The historical time includes a time when the PDU session 1 is established.

As an example, the historical time information may include time information (for example, time information T1) of establishment of the PDU session 1, to indicate the time when the PDU session 1 is established. As another example, the historical time information may include time information that the IP address of the PDU session 1 is allocated, to indicate a time when the IP address of the PDU session 1 is allocated.

Optionally, the SMF/UPF may further record the UE ID. The UE ID may be a UE SUPI or a GPSI, which is not limited.

1003: The UE reports UE data to the DCAF.

Specifically, step 1003 is similar to step 904 in FIG. 9, and for details, refer to the description in FIG. 9.

1004: The DCAF stores the UE data.

Specifically, step 1004 is similar to step 904a in FIG. 9, and for details, refer to the description in FIG. 9.

Different from step 904 in FIG. 9, because the DCAF does not record the association relationship between the UE IP and the UE ID of the PDU session of the UE, the DCAF cannot store the UE data by using the UE ID as an index.

1005: The PDU session 1 is released.

Specifically, step 1005 is similar to step 905 in FIG. 9, and for details, refer to the description in FIG. 9.

1006: The DCAF records that the association relationship between UE IP 1 and the UE ID is released at a moment T2.

Specifically, the SMF/UPF may obtain and record historical time information T2 and the IP address of the PDU session 1 at the historical time T2 (such as UE IP 1). The historical time includes a time when the PDU session 1 is released.

As an example, the historical time information may include time information of release of a PDU session 1 (such as time information T2), to indicate a time when the PDU session 1 is released. As another example, the historical time information may include time information that the IP address of the PDU session 1 is released, to indicate a time when the IP address of the PDU session 1 is released.

Through the above step 1002 and step 1006, the SMF/UPF may learn of and record that an association relationship exists between UE IP 1 and the UE ID in a time period from T1 to T2. The UE IP address stored in the SMF may be a private network IP address or a public network IP address of the UE, which is not limited.

1007: The PDU session 2 is established and released (repeat 1001 to 1006).

Specifically, establishment and data reporting processes of other PDU sessions of the UE, or establishment and data reporting processes of PDU sessions of other UEs are similar to the above step 1001 to step 1006.

At this point, the DCAF stores a large amount of data reported by the UE. The data is stored by using the UE IP as an index. Optionally, the DCAF may further store time information (for example, a timestamp) corresponding to the data.

1008: The NWDAF sends a data obtaining request message to the DCAF.

The data obtaining request message is used for requesting data of the UE at a first time, where the data may include first time information for indicating the first time.

Optionally, the data obtaining request message may further include the UE ID and/or condition information #2, where the condition information #2 is used for indicating a condition that the terminal device meets.

Specifically, step 1008 is similar to step 909 in FIG. 9, and for details, refer to the description in FIG. 9.

1009a: The DCAF sends a UE IP request to the SMF/UPF.

The UE IP request is used for requesting an IP address of the PDU session of the UE at the first time, and the UE IP request includes the first time information for indicating the first time. The first time information may be derived from the data obtaining request message in step 1008.

Optionally, the UE IP request may further include the UE ID and/or the condition information #2, where the condition information #2 is used for indicating a condition that the terminal device meets. The UE ID and/or the condition information #2 may also be derived from the data obtaining request message in step 1008.

As an example, when the data obtaining request message in step 1008 includes the condition information #2, the DCAF may obtain a corresponding UE ID list based on the condition information #2. In step 1009a, the UE IP request may carry the UE ID list, to request an IP address of a corresponding session of the UE at the first time.

As another example, when the data obtaining request message in step 1008 includes the condition information #2, the UE IP request in step 1009a may carry the condition information #2, to request an IP address at the first time of a session of UE that meets the condition information #2.

1009b: The SMF/UPF sends a UE IP response to the DCAF.

Specifically, the SMF/UPF maps, based on a stored association relationship of the UE IP, the UE ID, and the time, a UE IP corresponding to a UE ID at the first time indicated in the UE IP request, and returns the UE IP carried in the UE IP response to the DACF.

In some embodiments, when the UE IP request in step 1009a may carry the condition information #2, the SMF/UPF may obtain the UE ID list corresponding to the condition information #2, map a corresponding UE IP for each UE, and finally return a UE IP list carried in the UE IP response to the DCAF.

It should be noted that there may be one or more UE IPs corresponding to the UE at the first time, which is not limited. For example, when the first time falls within one historical time period, the UE IP corresponding to the UE at the first time is a UE IP of the historical time period; when the first time spans a plurality of historical time periods, the UE IP corresponding to the UE at the first time is a plurality of UE IPs corresponding to the plurality of historical time periods; and when the first time overlaps with a historical time period, the UE IP corresponding to the UE at the first time is a UE IP corresponding to the overlapped historical time period.

1010: The DCAF retrieves UE historical data based on the UE IP and the first time information.

Specifically, the DCAF may obtain, based on the UE IP response, the UE IP corresponding to the UE at the first time, and then retrieve, based on the UE IP and the first time information, the UE historical data from the data reported by the UE, that is, the data of the UE at the first time.

1011: The DCAF sends the UE historical data to the NWDAF.

Therefore, in this embodiment of this application, the IP address of the PDU session in which the UE reports data to the DCAF is stored on the SMF/UPF, and the DCAF requests the IP address of the UE at the first time from the SMF/UPF as needed when there is a data obtaining request of the UE at the first time, so that the DCAF can obtain the data of the UE at the first time based on the IP address of the PDU session of the UE at the first time. In this way, the DCAF can obtain the data corresponding to the IP address of the PDU session of the UE at the historical time.

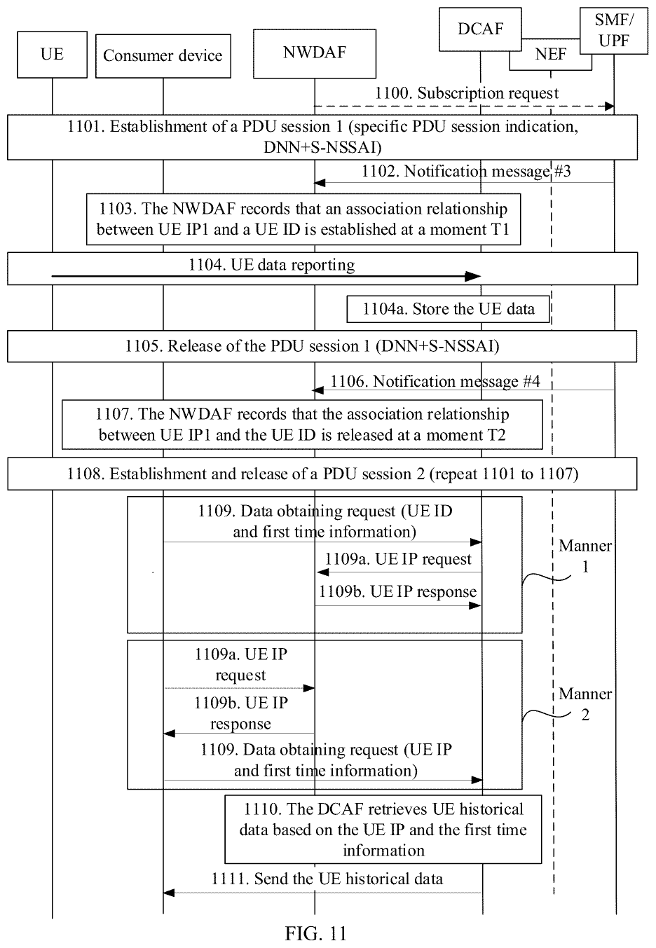

FIG. 11 is a schematic flowchart of another data obtaining method according to an embodiment of this application. A second communication device is an SMF or a UPF. The SMF or the UPF may send an IP address of a session of a terminal device at a historical time to an NWDAF. The following describes the data obtaining method with reference to FIG. 10.

It should be noted that when the DCAF communicates with a device in a network (such as the SMF/UPF) in this embodiment of this application, if the DCAF is an untrusted AF, it may need to be transferred or converted through an NEF. For example, the NEF may realize conversions such as: between external and internal geographic areas, between external and internal UE identifiers, and between external data and internal network time references, which is not limited.

Optionally, 1100: The NWDAF sends a subscription request to the SMF/UPF.

The subscription request is used for obtaining first information of the terminal device, and the first information is used for indicating an IP address of a PDU session of UE at a historical time. Specifically, for the subscription request, refer to related description in FIG. 9. Details are not described herein again.

1101: A PDU session 1 is established.

Specifically, step 1101 is similar to step 901 in FIG. 9, and for details, refer to the corresponding description in FIG. 9.

After receiving the PDU session establishment request of the UE, the SMF/UPF may determine first information of the UE if it is determined that the established PDU session 1 is used for the UE to report data to the DCAF, where the first information may indicate an IP address of the PDU session 1 of the UE at the historical time. For example, the first information may be carried in a notification message #3 and/or a notification message #4.

1102: The SMF/UPF sends the notification message #3 to the NWDAF.

Specifically, the notification message #3 is similar to the notification message #1 in step 902 of FIG. 9, and for details, refer to the description in FIG. 9. Details are not described herein again.

1103: The NWDAF records that an association relationship between UE IP 1 and the UE ID is established at a moment T1.

Specifically, that the NWDAF records that an association relationship between UE IP 1 and the UE ID is established at a moment T1 is similar to step 903 in FIG. 9, and for details, refer to the description in FIG. 9. Details are not described herein again.

1104: The UE reports UE data to the DCAF.

Specifically, step 1104 is similar to step 904 in FIG. 9, and for details, refer to the description in FIG. 9.

1104a: The DCAF stores the UE data.

Specifically, step 1104a is similar to step 904a in FIG. 9, and for details, refer to the description in FIG. 9.

Different from step 904 in FIG. 9, because the DCAF does not record the association relationship between the UE IP and the UE ID of the PDU session of the UE, the DCAF cannot store the UE data by using the UE ID as an index.

1105: The PDU session 1 is released.

Specifically, step 1105 is similar to step 905 in FIG. 9, and for details, refer to the description in FIG. 9.

1106: The SMF/UPF sends the notification message #4 to the NWDAF.

Specifically, the notification message #4 is similar to the notification message #2 in step 906 of FIG. 9, and for details, refer to the description in FIG. 9. Details are not described herein again.

1107: The NWDAF records that the association relationship between UE IP 1 and the UE ID is released at a moment T2.

Specifically, that the NWDAF records that the association relationship between UE IP 1 and the UE ID is released at a moment T2 is similar to step 907 in FIG. 9, and for details, refer to the description in FIG. 9. Details are not described herein again.

Through the above step 1103 and step 1107, the NWDAF may learn of and record that an association relationship exists between UE IP 1 and the UE ID in a time period from T1 to T2.

1108: The PDU session 2 is established and released (repeat 1101 to 1107).

Specifically, establishment and data reporting processes of other PDU sessions of the UE, or establishment and data reporting processes of PDU sessions of other UEs are similar to the above step 1101 to step 1107.

At this point, the DCAF stores a large amount of data reported by the UE. The data is stored by using the UE IP as an index. Optionally, the DCAF may further store time information (for example, a timestamp) corresponding to the data.

In some embodiments, a consumer device may request the data of the UE at the first time from the DCAF through step 1109, step 1109a, and step 1109b in manner 1.

1109: The consumer device sends a data obtaining request message to the DCAF.

1109a: The DCAF sends a UE IP request to the NWDAF.

1109b: The NWDAF sends a UE IP response to the DCAF.

Specifically, for the data obtaining request message, refer to the related description in FIG. 9, and for the UE IP request and the UE IP response, refer to the related description in FIG. 10.

In some other embodiments, the consumer device may request the data of the UE at the first time from the DCAF through step 1109a, step 1109b, and step 1109 in manner 2.

1109a: The consumer device sends a UE IP request to the NWDAF.

1109b: The NWDAF sends a UE IP response to the consumer device.

Specifically, for the UE IP request and the UE IP response, refer to the related description in FIG. 10.

1109: The consumer device sends a data obtaining request to the DCAF, to request the data of the UE at the first time. The data obtaining request includes the UE IP and first time information. The UE IP is obtained through the UE IP response.

It should be noted that when the consumer device is the NWDAF, step 1109a and step 1109b in manner 2 belong to internal operations of the NWDAF and may be omitted.

1110: The DCAF retrieves UE historical data based on the UE IP and the first time information.

1111: The DCAF sends the UE historical data to the NWDAF.

Specifically, for step 1110 and step 1111, refer to the corresponding description in FIG. 10.

Therefore, in this embodiment of this application, the SMF/UPF sends, to the NWDAF, the IP address of the PDU session in which the UE reports data to the DCAF, and the IP address of the UE at the first time is requested from the NWDAF as needed when there is a data obtaining request of the UE at the first time, so that the DCAF can obtain the data of the UE at the first time based on the IP address of the PDU session of the UE at the first time. In this way, the DCAF can obtain the data corresponding to the IP address of the PDU session of the UE at the historical time.

The specific implementations of this application are described in detail above with reference to the accompanying drawings. However, this application is not limited to the specific details in the foregoing implementations, multiple simple deformations may be made to the technical solution of this application within a range of the technical concept of this application, and these simple deformations fall within the protection scope of this application. For example, the specific technical features described in the foregoing specific implementations may be combined in any proper manner in a case without conflict, and to avoid unnecessary repetition, various possible combinations are not otherwise explained in this application. For another example, various implementations of this application may also be randomly combined, and should also be regarded as the content disclosed in this application as long as they do not depart from the spirit of this application.

It should be further understood that sequence numbers of the foregoing processes do not mean execution sequences in various method embodiments of this application. The execution sequences of the processes should be determined according to functions and internal logic of the processes, and should not be construed as any limitation on the implementation processes of the embodiments of this application. It should be understood that these sequence numbers may be interchangeable in proper circumstances, so that the embodiments of this application described can be implemented in an order other than the order illustrated or described.

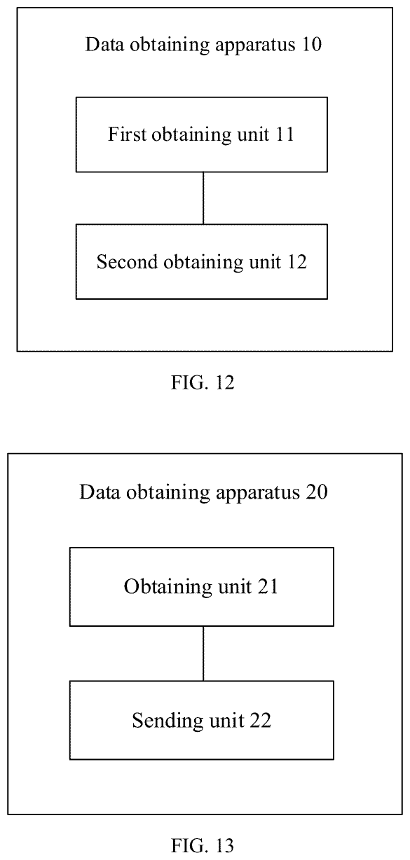

The foregoing describes in detail the method embodiments of this application. The following describes in detail apparatus embodiments of this application with reference to FIG. 12 to FIG. 15.

FIG. 12 is a schematic diagram of a structure of a data obtaining apparatus 10 according to an embodiment of this application. The data obtaining apparatus 10 is, for example, the first communication device described above. As shown in FIG. 12, the data obtaining apparatus 10 may include: a first obtaining unit 11 and a second obtaining unit 12.

The first obtaining unit 11 is configured to obtain first information of a terminal device, where the first information is used for indicating address information of a session of the terminal device at a historical time, and the session includes a session in which the terminal device reports data to the first communication device; and
the second obtaining unit 12 is configured to obtain, based on the first information, data of the terminal device at a first time, where the first time overlaps with the historical time.

In some embodiments, the first obtaining unit 11 is specifically configured to:
obtain the first information from a second communication device, where the first information includes historical time information and the address information of the session of the terminal device at the historical time, and the historical time information is used for indicating the historical time.

In some embodiments, the historical time information includes:
time information of establishment of the session; and/or
time information of release of the session.

In some embodiments, the first obtaining unit 11 is specifically configured to:
obtain the first information from a second communication device, where the first information includes address information corresponding to the terminal device at a time when the session is established.

In some embodiments, the first information further includes second indication information, and the second indication information is used for indicating to the first communication device that the session is established.

In some embodiments, the first obtaining unit 11 is specifically configured to:
obtain the first information from a second communication device, where the first information includes address information corresponding to the terminal device at a time when the session is released.

In some embodiments, the first information further includes third indication information, and the third indication information is used for indicating to the first communication device that the session is released.

In some embodiments, the first obtaining unit 11 is specifically configured to:
send a first request message to a second communication device, where the first request message includes first time information, and the first time information is used for indicating the first time; and
receive the first information from the second communication device, where the first information includes address information of the session of the terminal device at the first time.

In some embodiments, the second obtaining unit 12 is specifically configured to:
determine, based on the first information, first address information of the session of the terminal device at the first time; and
obtain, based on the first address information, data of the terminal device at the first time.

In some embodiments, the first information further includes an identifier of the terminal device, and the apparatus 10 further includes a storage unit, configured to: store the data of the terminal device by using the identifier of the terminal device as an index.

In some embodiments, the second obtaining unit 12 is specifically configured to:
obtain data corresponding to the identifier of the terminal device at the first time.

In some embodiments, the apparatus 10 further includes a receiving unit, configured to:
receive a second request message sent by a consumer device, where the second request message includes first time information, and the second request message is used for obtaining the data of the terminal device at the first time; and
the apparatus 10 further includes a sending unit, configured to:
send a response message to the consumer device, where the response message includes the data of the terminal device at the first time.

In some embodiments, the second request message includes an identifier of the terminal device or first condition information, and the first condition information is used for indicating a condition that the terminal device meets.

In some embodiments, the second request message includes address information of the session of the terminal device at the first time.

In some embodiments, the apparatus 10 further includes a sending unit, configured to:
send a subscription request message to the second communication device, where the subscription request message is used for obtaining the first information of the terminal device.

In some embodiments, the subscription request message includes an identifier of the terminal device or second condition information, and the second condition information is used for indicating a condition that the terminal device meets.

In some embodiments, the second communication device includes a session management function (SMF), a user plane function (UPF), or a network data analytics function (NWDAF).

In some embodiments, the first communication device includes a data collection application function (DCAF).

In some embodiments, the address information includes an Internet Protocol (IP) address.

It should be understood that the apparatus embodiment and the method embodiment may correspond to each other, and for similar description, refer to the method embodiment. To avoid repetition, details are not described herein again. Specifically, the data obtaining apparatus 10 shown in FIG. 12 may perform the method embodiment in FIG. 6, and the foregoing and other operations and/or functions of each module in the data obtaining apparatus 10 are respectively used for realizing a corresponding procedure in the method embodiment of FIG. 6. For brevity, details are not described herein again.

FIG. 13 is a schematic diagram of a structure of a data obtaining apparatus 20 according to an embodiment of this application. The data obtaining apparatus 20 is, for example, the second communication device described above. As shown in FIG. 13, the data obtaining apparatus 20 may include: an obtaining unit 21 and a sending unit 22.

The obtaining unit 21 is configured to obtain first information of a terminal device, where the first information is used for indicating address information of a session of the terminal device at a historical time, and the session includes a session in which the terminal device reports data to a first communication device; and
the sending module 22 is configured to send the first information to the first communication device.

In some embodiments, the first information includes historical time information and the address information of the session of the terminal device at the historical time, and the historical time information is used for indicating the historical time.

In some embodiments, the historical time information includes:
time information of establishment of the session; and/or
time information of release of the session.

In some embodiments, the obtaining unit 21 is specifically configured to:
receive a session establishment request message from the terminal device, where the session establishment request message is used for establishing the session; and
determine address information corresponding to the terminal device at a time when the session is established as the first information.

In some embodiments, the session establishment request message includes first indication information, and the first indication information is used for indicating that the session is used for the terminal device to report data to the first communication device.

In some embodiments, the first information further includes second indication information, and the second indication information is used for indicating to the first communication device that the session is established.

In some embodiments, the obtaining unit 21 is specifically configured to:
receive a session release request message from the terminal device, where the session release request message is used for releasing the session; and
determine address information corresponding to the terminal device at a time when the session is released as the first information.

In some embodiments, the first information further includes third indication information, and the third indication information is used for indicating to the first communication device that the session is released.

In some embodiments, the obtaining unit 21 is specifically configured to:
receive a first request message from the first communication device, where the first request message includes first time information, and the first time information is used for indicating the first time; and
determine address information of the session of the terminal device at the first time as the first information.

In some embodiments, the first information further includes an identifier of the terminal device.

In some embodiments, the apparatus 20 further includes a receiving unit, configured to:
receive a subscription request message from the first communication device, where the subscription request message is used for obtaining the first information of the terminal device.

In some embodiments, the subscription request message includes an identifier of the terminal device or second condition information, and the second condition information is used for indicating a condition that the terminal device meets.

It should be understood that the apparatus embodiment and the method embodiment may correspond to each other, and for similar description, refer to the method embodiment. To avoid repetition, details are not described herein again. Specifically, the data obtaining apparatus 20 shown in FIG. 13 may perform the method embodiment in FIG. 7, and the foregoing and other operations and/or functions of each module in the data obtaining apparatus 20 are respectively used for realizing a corresponding procedure in the method embodiment of FIG. 7. For brevity, details are not described herein again.

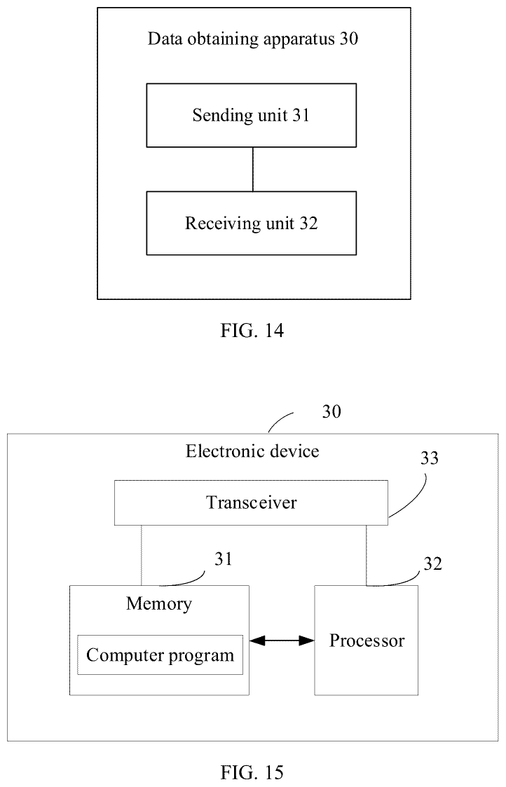

FIG. 14 is a schematic diagram of a structure of a data obtaining apparatus 30 according to an embodiment of this application. The data obtaining apparatus 30 is, for example, the consumer device described above. As shown in FIG. 14, the data obtaining apparatus 30 may include: a sending unit 31 and a receiving unit 32.

The sending unit 31 is configured to send a second request message to a first communication device, where the second request message includes first time information, and the second request message is used for obtaining data of a terminal device at a first time; and
the receiving unit 32 is configured to receive a response message from the first communication device, where the response message includes the data of the terminal device at the first time, the data of the terminal device at the first time is obtained based on first information of the terminal device, and the first information is used for indicating address information of a session of the terminal device at a historical time.

In some embodiments, the second request message includes an identifier of the terminal device or first condition information, and the first condition information is used for indicating a condition that the terminal device meets.

In some embodiments, the second request message includes address information of the session of the terminal device at the first time.

It should be understood that the apparatus embodiment and the method embodiment may correspond to each other, and for similar description, refer to the method embodiment. To avoid repetition, details are not described herein again. Specifically, the data obtaining apparatus 30 shown in FIG. 14 may perform the method embodiment in FIG. 8, and the foregoing and other operations and/or functions of each module in the data obtaining apparatus 30 are respectively used for realizing a corresponding procedure in the method embodiment of FIG. 8. For brevity, details are not described herein again.

The data obtaining apparatus in this embodiment of this application is described above from the perspective of a functional module with reference to the accompanying drawings. It should be understood that the functional module may be implemented in a form of hardware, by instructions in a form of software, and by a combination of hardware and software modules. Specifically, the steps of the method embodiments in the embodiments of this application may be completed by a hardware integrated logical circuit in the processor and/or instructions in a form of software. The steps in the methods disclosed with reference to the embodiments of this application may be directly performed and completed by a hardware encoding processor, or may be performed and completed by using a combination of hardware in the encoding processor and a software module. Optionally, the software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing method embodiments in combination with hardware of the processor.

FIG. 15 is a schematic block diagram of an electronic device 30 according to an embodiment of this application. The electronic device may be the communication apparatus described above, such as the terminal device or the network side device.

As shown in FIG. 15, the electronic device 30 may include:
a memory 31 and a processor 32, where the memory 31 is used for storing a computer program and transmitting the program code to the processor 32. In other words, the processor 32 may invoke and run the computer program in the memory 31, to implement the communication method in the embodiments of this application.

For example, the processor 32 may be configured to perform the foregoing method embodiments based on an instruction in the computer program.

In some embodiments of this application, the processor 32 may include but is not limited to:
a general-purpose processor, a digital signal processor (DSP), an application specific integrated circuit (ASIC), a field programmable gate array (FPGA) or another programmable logic device, a discrete gate or transistor logic device, or a discrete hardware component.

In some embodiments of this application, the memory 31 may include but is not limited to:
a volatile memory and/or a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (synchlink DRAM, SLDRAM), and a direct rambus random access memory (Direct Rambus RAM, DR RAM).

In some embodiments of this application, the computer program may be divided into one or more modules, which are stored in the memory 31 and executed by the processor 32 to complete the method provided in this application. The one or more modules may be a series of computer program instruction segments that can accomplish specific functions, and the instruction segments are configured to describe an execution process of the computer program in the electronic device.

As shown in FIG. 15, the electronic device 30 may further include:
a transceiver 33, where the transceiver 33 may be connected to the processor 32 or the memory 31.

The processor 32 may control the transceiver 33 to communicate with other devices, and specifically, may send information or data to other devices, or receive information or data sent by other devices. The transceiver 33 may include a transmitter and a receiver. The transceiver 33 may further include an antenna. There may be one or more antennas.

It should be understood that all components in the electronic device are connected by using a bus system. In addition to a data bus, the bus system further includes a power bus, a control bus, and a status signal bus.

According to the methods provided in the embodiments of this application, an embodiment of this application further provides a communication system. The communication system includes the first communication device, the second communication device, and the consumer device. Optionally, the communication system may further include a terminal device.

This application further provides a computer storage medium, having a computer program stored thereon. When the computer program is executed by a computer, the computer is enabled to perform the method of the foregoing method embodiment. In other words, an embodiment of this application further provides a computer program product including an instruction, and when the instruction is executed by a computer, the computer is enabled to perform the method of the foregoing method embodiment.

When software is used to implement the embodiments, all or a part of the embodiments may be implemented in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device such as a server or a data center integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art may be aware that, in combination with the examples described in embodiments disclosed in this specification, modules and algorithm steps may be implemented by electronic hardware or a combination of computer software and electronic hardware. Whether the functions are performed by hardware or software depends on particular applications and design constraints of the technical solutions. A person skilled in the art can use different methods to implement the described functions for each particular application, but it should not be considered that the implementation goes beyond the scope of the embodiments of this application.

In the several embodiments provided in this application, the disclosed system, apparatus, and method may be implemented in other manners. For example, the apparatus embodiments described above are merely examples. For example, division into the modules is merely a logical function division and there may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate parts may or may not be physically separate, and parts displayed as modules may or may not be physical modules, in other words, may be located in one position, or may be distributed on a plurality of network units. Some or all the modules may be selected according to actual needs to achieve the objectives of the solutions of embodiments. For example, functional modules in the embodiments of this application may be integrated into one processing module, or may exist alone physically, or two or more modules may be integrated into one module.

The foregoing descriptions are merely specific implementations of the embodiments of this application, but are not intended to limit the protection scope of the embodiments of this application. Any variation or replacement readily figured out by a person skilled in the art within the technical scope disclosed in the embodiments of this application shall fall within the protection scope of the embodiments of this application. Therefore, the protection scope of the embodiments of this application shall be subject to the protection scope of the claims.

1. A data obtaining method, comprising:
obtaining, by a first communication device, first information of a terminal device, wherein the first information is used for indicating address information of a session of the terminal device at a historical time, and the session comprises a session in which the terminal device reports data to the first communication device; and
obtaining, by the first communication device based on the first information, data of the terminal device at a first time, wherein the first time overlaps with the historical time.

2. The method according to claim 1, wherein the obtaining, by a first communication device, first information of a terminal device comprises:
obtaining, by the first communication device, the first information from a second communication device, wherein the first information comprises historical time information and the address information of the session of the terminal device at the historical time, and the historical time information is used for indicating the historical time.

3. The method according to claim 2, wherein the historical time information comprises:
time information of establishment of the session; and/or
time information of release of the session.

4. The method according to claim 1, wherein the obtaining, by a first communication device, first information of a terminal device comprises:
obtaining, by the first communication device, the first information from a second communication device, wherein the first information comprises address information corresponding to the terminal device at a time when the session is established.

5. The method according to claim 4, wherein the first information further comprises second indication information, and the second indication information is used for indicating to the first communication device that the session is established.

6. The method according to claim 1, wherein the obtaining, by a first communication device, first information of a terminal device comprises:
obtaining, by the first communication device, the first information from a second communication device, wherein the first information comprises address information corresponding to the terminal device at a time when the session is released.

7. The method according to claim 6, wherein the first information further comprises third indication information, and the third indication information is used for indicating to the first communication device that the session is released.

8. The method according to claim 1, wherein the first information further comprises an identifier of the terminal device, and the method further comprises:
storing, by the first communication device, the data of the terminal device by using the identifier of the terminal device as an index.

9. The method according to claim 8, wherein the obtaining, by the first communication device based on the first information, data of the terminal device at a first time comprises:
obtaining, by the first communication device, data corresponding to the identifier of the terminal device at the first time.

10. A data obtaining method, comprising:
obtaining, by a second communication device, first information of a terminal device, wherein the first information is used for indicating address information of a session of the terminal device at a historical time, and the session comprises a session in which the terminal device reports data to a first communication device; and
sending, by the second communication device, the first information to the first communication device.

11. The method according to claim 10, wherein the first information comprises historical time information and the address information of the session of the terminal device at the historical time, and the historical time information is used for indicating the historical time.

12. The method according to claim 11, wherein the historical time information comprises:
time information of establishment of the session; and/or
time information of release of the session.

13. The method according to claim 10, wherein the obtaining, by a second communication device, first information of a terminal device comprises:
receiving, by the second communication device, a session establishment request message from the terminal device, wherein the session establishment request message is used for establishing the session; and
determining, by the second communication device, address information corresponding to the terminal device at a time when the session is established as the first information.

14. The method according to claim 13, wherein the session establishment request message comprises first indication information, and the first indication information is used for indicating that the session is used for the terminal device to report data to the first communication device.

15. The method according to claim 10, wherein the obtaining, by a second communication device, first information of a terminal device comprises:
receiving, by the second communication device, a session release request message from the terminal device, wherein the session release request message is used for releasing the session; and
determining, by the second communication device, address information corresponding to the terminal device at a time when the session is released as the first information.

16. The method according to claim 10, wherein the first information further comprises an identifier of the terminal device.

17. A data obtaining method, comprising:
sending, by a consumer device, a second request message to a first communication device, wherein the second request message comprises first time information, and the second request message is used for obtaining data of a terminal device at a first time; and
receiving, by the consumer device, a response message from the first communication device, wherein the response message comprises the data of the terminal device at the first time, the data of the terminal device at the first time is obtained based on first information of the terminal device, and the first information is used for indicating address information of a session of the terminal device at a historical time.

18. The method according to claim 17, wherein the second request message comprises address information of the session of the terminal device at the first time.

19. A communication device, comprising:
a processor and a memory, wherein the memory is configured to store a computer program, and the processor is configured to invoke and run the computer program stored in the memory to perform the method according to claim 1.

20. A communication device, comprising:
a processor and a memory, wherein the memory is configured to store a computer program, and the processor is configured to invoke and run the computer program stored in the memory to perform the method according to claim 10.
